(19) United States
(12) Patent Application Publication
(10) Pub. No.: US 2022/0343905 A1
(43) Pub. Date: Oct. 27, 2022

(54) CONTEXT-AWARE SAFETY ASSISTANT FOR WORKER SAFETY

(71) Applicant: 3M INNOVATIVE PROPERTIES COMPANY, St. Paul, MN (US)

(72) Inventors: Nigel B. Boxall, Workingham (GB); Caroline M. Ylitalo, Stillwater, MN (US)

(21) Appl. No.: 17/753,742

(22) PCT Filed: Sep. 11, 2020
(86) PCT No.: PCT/IB2020/058478

§ 371 Date: Mar. 14, 2022

Related U.S. Application Data
(60) Provisional application No. 62/900,804, filed on Sep. 16, 2019.

(51) Int. Cl. G10L 15/187; G10L 15/18

(52) U.S. Cl. CPC G10L 15/187; G10L 15/1815

(57) ABSTRACT

In some examples, a computing device may receive audio data that represents a first plurality of utterances from a worker, wherein the first plurality of utterances represents at least one expression of the worker about a safety event. The computing device may select a set of safety context data that characterizes at least one of the worker, a worker environment, or an article of PPE. The computing device may determine, based at least in part on the safety context data and applying natural language processing to the first plurality of utterances, safety response data that represents a second plurality of utterances that is semantically responsive to the expression of the worker. The computing device may generate an output based at least in part on the safety response data that represents a second plurality of utterances that is semantically responsive to the expression of the worker about the safety event.

### TECHNICAL FIELD

The present disclosure relates to the field of personal protection equipment. More specifically, the present disclosure relates to personal protection equipment that generate data.

### BACKGROUND

When working in areas where there is known to be, or there is a potential of there being, dusts, fumes, gases, airborne contaminants, fall hazards, hearing hazards or any other hazards that are potentially hazardous or harmful to health, it is usual for a worker to use personal protection equipment (PPE), such as respirator or a clean air supply source. While a large variety of personal protection equipment are available, some commonly used devices include powered air purifying respirators (PAPR), self-contained breathing apparatuses, fall protection harnesses, ear muffs, face shields, and welding masks. For instance, a PAPR typically includes a blower system comprising a fan powered by an electric motor for delivering a forced flow of air through a tube to a head top worn by a worker. A PAPR typically includes a device that draws ambient air through a filter, forces the air through a breathing tube and into a helmet or head top to provide filtered air to a worker's breathing zone, around their nose or mouth. In some examples, various personal protection equipment may generate various types of data.

### SUMMARY

This disclosure is directed to a system that may improve worker safety by applying safety context data (e.g., characterizing at least one of the worker, a worker environment, or PPE) in natural language processing of utterances from a worker to generate an output that is semantically responsive to an expression of the worker about the safety event. A worker who engages in activities in a work environment may be exposed to different hazards, require certain types of PPE or proper fit of PPE, or require information relating to situational awareness of the worker, PPE of the worker, and/or the work environment of the worker, to name only a few examples. Because workers may be subjected to complex tasks, dangerous situations, or strenuous physical activities, quickly and safely obtaining information about safety events that are of relevance to the worker may be difficult or not possible. While some conventional systems may rely on a worker's pre-existing knowledge of pre-defined commands that have specific meaning to a computing device, such conventional systems may be difficult for a worker to use because the worker may not remember or correctly pronounce such pre-defined commands, particularly under challenging work conditions. Furthermore, because a single concept in a spoken language may be represented with alternative words (e.g., “automobile”, “car”, “vehicle”), a worker may express a request for information using an alternative word for a pre-defined command that is not recognized by the system. As such, a worker in need of information that is timely, relevant, and responsive to a verbal expression of the worker may experience difficulty, or altogether avoid, using pre-defined command systems. Pre-defined command systems may also fail to use contextual data (e.g., characterizing at least one of the worker, a worker environment, or PPE) to improve the relevance of any output that is semantically responsive to the expression of the worker about the safety event. Pre-defined command systems may also include limitations that only permit queries for a single entity, such as a work environment, rather than permitting complex queries with multiple entities such as “are all the workers in my work environment protected by the correct types of PPE”.

Rather than using pre-defined commands in the absence of contextual data, techniques of this disclosure may apply natural language processing to a set of worker utterances in conjunction with safety context data to increase the relevance of one or more computer-generated responses that are semantically responsive to the initial verbal expression of the worker about the safety event. Because techniques of this disclosure apply natural language processing to a set of worker utterances in conjunction with safety context data to generate responses, the worker may speak in his or her own familiar and personal style to receive computer-generated responses that are semantically responsive to the expression of the worker about the safety event. In this way, techniques of this disclosure may reduce the amount of worker effort to request information verbally and receive audible responses and may increase the likelihood that the worker initiates requests for information about safety events. Consequently, techniques of this disclosure may improve worker safety by simplifying the audio worker interface through which the worker sends and receives information about safety events.

In some examples, a computing device may include one or more computer processors; and a memory. The computing device may receive audio data that represents a first plurality of utterances from a worker, wherein the first plurality of utterances represents at least one expression of the worker about a safety event. The computing device may select a set of safety context data that characterizes at least one of the worker, a worker environment, or an article of personal protection equipment. The computing device may determine, based at least in part on safety context data and applying natural language processing to the first plurality of utterances, safety response data that represents a second plurality of utterances that are semantically responsive to the expression of the worker about the safety event. The computing device may generate an output based at least in part on the second plurality of utterances.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system with a safety assistant, in accordance with various techniques of this disclosure.

FIG. 2 is a block diagram illustrating an operating perspective of the personal protection equipment management system shown in FIG. 1 in accordance with various techniques of this disclosure.

FIG. 3 illustrates an example system including a mobile computing device, a set of personal protection equipment communicatively coupled to the mobile computing device, and a personal protection equipment management system communicatively coupled to the mobile computing device, in accordance with techniques of this disclosure.

FIG. 4 illustrates an example computing device, in accordance with techniques of this disclosure.

FIG. 5 illustrates an example architecture of a safety assistant, in accordance with techniques of this disclosure.

FIG. 6 is a flow diagram illustrating example operations of a computing device in accordance with one or more techniques of this disclosure.

It is to be understood that the embodiments may be utilized, and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

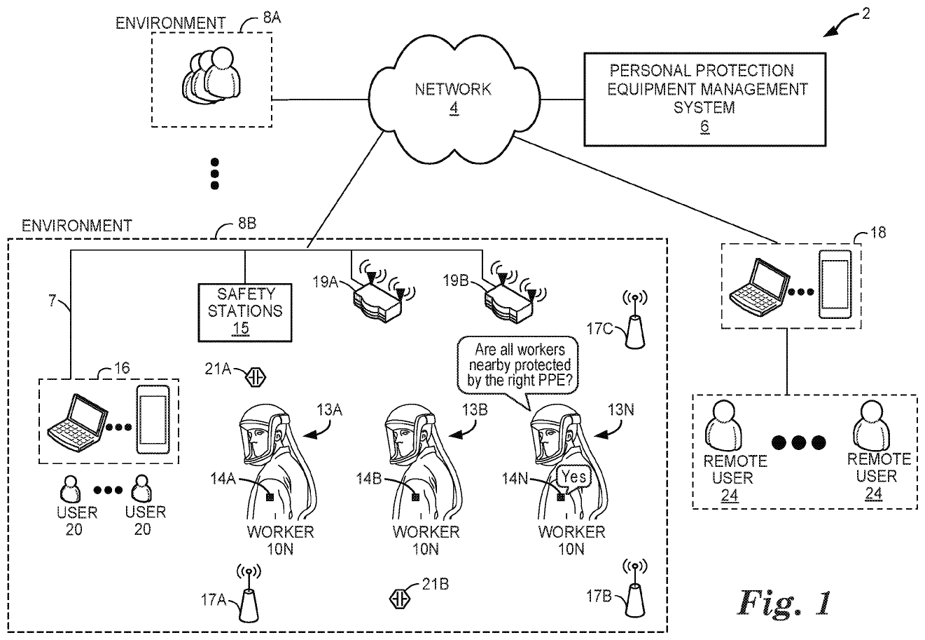

FIG. 1 is a block diagram illustrating an example system 2 with a safety assistant, in accordance with various techniques of this disclosure. As shown in FIG. 1, system 2 may include a personal protection equipment management system (PPEMS) 6. PPEMS 6 may provide a safety assistant, data acquisition, monitoring, activity logging, reporting, predictive analytics, PPE control, and alert generation, to name only a few examples. For example, PPEMS 6 includes an underlying analytics and safety event prediction engine and alerting system in accordance with various examples described herein. In some examples, a safety event may refer to activities of a worker of personal protection equipment (PPE), a condition of the PPE, or an environmental condition (e.g., which may be hazardous). In some examples, a safety event may be an injury or worker condition, workplace harm, or regulatory violation. For example, in the context of fall protection equipment, a safety event may be misuse of the fall protection equipment, a worker of the fall equipment experiencing a fall, or a failure of the fall protection equipment. In the context of a respirator, a safety event may be misuse of the respirator, a worker of the respirator not receiving an appropriate quality and/or quantity of air, or failure of the respirator. A safety event may also be associated with a hazard in the environment in which the PPE is located. In some examples, an occurrence of a safety event associated with the article of PPE may include a safety event in the environment in which the PPE is used or a safety event associated with a worker using the article of PPE. In some examples, a safety event may be an indication that PPE, a worker, and/or a worker environment are operating, in use, or acting in a way that is normal or abnormal operation, where normal or abnormal operation is a predetermined or predefined condition of acceptable or safe operation, use, or activity. In some examples, a safety event may be an indication of an unsafe condition, wherein the unsafe condition represents a state outside of a set of defined thresholds, rules, or other limits configured by a human operator and/or are machine-generated.

Examples of PPE include, but are not limited to respiratory protection equipment (including disposable respirators, reusable respirators, powered air purifying respirators, and supplied air respirators), protective eyewear, such as visors, goggles, filters or shields (any of which may include augmented reality functionality), protective headwear, such as hard hats, hoods or helmets, hearing protection (including ear plugs and ear muffs), protective shoes, protective gloves, other protective clothing, such as coveralls and aprons, protective articles, such as sensors, safety tools, detectors, global positioning devices, mining cap lamps, fall protection harnesses, exoskeletons, self-retracting lifelines, heating and cooling systems, gas detectors, and any other suitable gear. In some examples, a data hub, such as data hub 14N may be an article of PPE.

As further described below, PPEMS 6 provides an integrated suite of personal safety protection equipment management tools and implements various techniques of this disclosure. That is, PPEMS 6 provides an integrated, end-to-end system for managing personal protection equipment, e.g., safety equipment, used by workers 10 within one or more physical environments 8, which may be construction sites, mining or manufacturing sites or any physical environment. The techniques of this disclosure may be realized within various parts of computing environment 2.

As shown in the example of FIG. 1, system 2 represents a computing environment in which a computing device within of a plurality of physical environments 8A-8B (collectively, environments 8) electronically communicate with PPEMS 6 via one or more computer networks 4. Each of physical environment 8 represents a physical environment, such as a work environment, in which one or more individuals, such as workers 10, utilize personal protection equipment while engaging in tasks or activities within the respective environment.

In this example, environment 8A is shown as generally as having workers 10, while environment 8B is shown in expanded form to provide a more detailed example. In the example of FIG. 1, a plurality of workers 10A-10N (“workers 10”) are shown as utilizing respective respirators 13A-13N (“respirators 13”).

As further described herein, each of respirators 13 may include embedded sensors or monitoring devices and processing electronics configured to capture data in real-time as a worker (e.g., worker) engages in activities while wearing the respirators. For example, as described in greater detail herein, respirators 13 may include a number of components (e.g., a head top, a blower, a filter, and the like) respirators 13 may include a number of sensors for sensing or controlling the operation of such components. A head top may include, as examples, a head top visor position sensor, a head top temperature sensor, a head top motion sensor, a head top impact detection sensor, a head top position sensor, a head top battery level sensor, a head top head detection sensor, an ambient noise sensor, or the like. A blower may include, as examples, a blower state sensor, a blower pressure sensor, a blower run time sensor, a blower temperature sensor, a blower battery sensor, a blower motion sensor, a blower impact detection sensor, a blower position sensor, or the like. A filter may include, as examples, a filter presence sensor, a filter type sensor, or the like. Each of the above-noted sensors may generate usage data, as described herein.

In addition, each of respirators 13 may include one or more output devices for outputting data that is indicative of operation of respirators 13 and/or generating and outputting communications to the respective worker 10. For example, respirators 13 may include one or more devices to generate audible feedback (e.g., one or more speakers), visual feedback (e.g., one or more displays, light emitting diodes (LEDs) or the like), or tactile feedback (e.g., a device that vibrates or provides other haptic feedback).

In general, each of environments 8 include computing facilities (e.g., a local area network) by which respirators 13 are able to communicate with PPEMS 6. For example, environments 8 may be configured with wireless technology, such as 802.11 wireless networks, 802.15 ZigBee networks, and the like. In the example of FIG. 1, environment 8B includes a local network 7 that provides a packet-based transport medium for communicating with PPEMS 6 via network 4. In addition, environment 8B includes a plurality of wireless access points 19A, 19B that may be geographically distributed throughout the environment to provide support for wireless communications throughout the work environment.

Each of respirators 13 is configured to communicate data, such as sensed motions, events and conditions, via wireless communications, such as via 802.11 WiFi protocols, Bluetooth protocol or the like. Respirators 13 may, for example, communicate directly with a wireless access point 19. As another example, each worker 10 may be equipped with a respective one of wearable communication hubs 14A-14M that enable and facilitate communication between respirators 13 and PPEMS 6. For example, respirators 13 as well as other PPEs (such as fall protection equipment, hearing protection, hardhats, or other equipment) for the respective worker 10 may communicate with a respective communication hub 14 via Bluetooth or other short range protocol, and the communication hubs may communicate with PPEMs 6 via wireless communications processed by wireless access points 19. Although shown as wearable devices, hubs 14 may be implemented as stand-alone devices deployed within environment 8B. In some examples, hubs 14 may be articles of PPE. In some examples, communication hubs 14 may be an intrinsically safe computing device, smartphone, wrist- or head-wearable computing device, or any other computing device.

In general, each of hubs 14 operates as a wireless device for respirators 13 relaying communications to and from respirators 13 and may be capable of buffering usage data in case communication is lost with PPEMS 6. Moreover, each of hubs 14 is programmable via PPEMS 6 so that local alert rules may be installed and executed without requiring a connection to the cloud. As such, each of hubs 14 provides a relay of streams of usage data from respirators 13 and/or other PPEs within the respective environment, and provides a local computing environment for localized alerting based on streams of events in the event communication with PPEMS 6 is lost.

As shown in the example of FIG. 1, an environment, such as environment 8B, may also include one or more wireless-enabled beacons, such as beacons 17A-17C, that provide accurate location information within the work environment. For example, beacons 17A-17C may be GPS-enabled such that a controller within the respective beacon may be able to precisely determine the position of the respective beacon. Based on wireless communications with one or more of beacons 17, a given respirator 13 or communication hub 14 worn by a worker 10 is configured to determine the location of the worker within work environment 8B. In this way, event data (e.g., usage data) reported to PPEMS 6 may be stamped with positional information to aid analysis, reporting and analytics performed by the PPEMS.

In addition, an environment, such as environment 8B, may also include one or more wireless-enabled sensing stations, such as sensing stations 21A, 21B. Each sensing station 21 includes one or more sensors and a controller configured to output data indicative of sensed environmental conditions. Moreover, sensing stations 21 may be positioned within respective geographic regions of environment 8B or otherwise interact with beacons 17 to determine respective positions and include such positional information when reporting environmental data to PPEMS 6. As such, PPEMS 6 may be configured to correlate the sense environmental conditions with the particular regions and, therefore, may utilize the captured environmental data when processing event data received from respirators 13. For example, PPEMS 6 may utilize the environmental data to aid generating alerts or other instructions for respirators 13 and for performing predictive analytics, such as determining any correlations between certain environmental conditions (e.g., heat, humidity, visibility) with abnormal worker behavior or increased safety events. As such, PPEMS 6 may utilize current environmental conditions to aid prediction and avoidance of imminent safety events. Example environmental conditions that may be sensed by sensing stations 21 include but are not limited to temperature, humidity, presence of gas, pressure, visibility, wind and the like.

In example implementations, an environment, such as environment 8B, may also include one or more safety stations 15 distributed throughout the environment to provide viewing stations for accessing respirators 13. Safety stations 15 may allow one of workers 10 to check out respirators 13 and/or other safety equipment, verify that safety equipment is appropriate for a particular one of environments 8, and/or exchange data. For example, safety stations 15 may transmit alert rules, software updates, or firmware updates to respirators 13 or other equipment. Safety stations 15 may also receive data cached on respirators 13, hubs 14, and/or other safety equipment. That is, while respirators 13 (and/or data hubs 14) may typically transmit usage data from sensors of respirators 13 to network 4 in real time or near real time, in some instances, respirators 13 (and/or data hubs 14) may not have connectivity to network 4. In such instances, respirators 13 (and/or data hubs 14) may store usage data locally and transmit the usage data to safety stations 15 upon being in proximity with safety stations 15. Safety stations 15 may then upload the data from respirators 13 and connect to network 4. In some examples, a data hub may be an article of PPE.

In addition, each of environments 8 include computing facilities that provide an operating environment for end-worker computing devices 16 for interacting with PPEMS 6 via network 4. For example, each of environments 8 typically includes one or more safety managers responsible for overseeing safety compliance within the environment. In general, each worker 20 (or “user”) may interact with computing devices 16 to access PPEMS 6. Each of environments 8 may include systems. Similarly, remote workers 24 may use computing devices 18 to interact with PPEMS via network 4. For purposes of example, the end-worker computing devices 16, 18 may be laptops, desktop computers, mobile devices such as tablets or so-called smart phones and the like.

Workers 20, 24 interact with PPEMS 6 to control and actively manage many aspects of safely equipment utilized by workers 10, such as accessing and viewing usage records, analytics and reporting. For example, workers 20, 24 may review usage information acquired and stored by PPEMS 6, where the usage information may include data specifying worker queries to or responses from safety assistants, data specifying starting and ending times over a time duration (e.g., a day, a week, or the like), data collected during particular events, such as lifts of a visor of respirators 13, removal of respirators 13 from a head of workers 10, changes to operating parameters of respirators 13, status changes to components of respirators 13 (e.g., a low battery event), motion of workers 10, detected impacts to respirators 13 or hubs 14, sensed data acquired from the worker, environment data, and the like. In addition, workers 20, 24 may interact with PPEMS 6 to perform asset tracking and to schedule maintenance events for individual pieces of safety equipment, e.g., respirators 13, to ensure compliance with any procedures or regulations. PPEMS 6 may allow workers 20, 24 to create and complete digital checklists with respect to the maintenance procedures and to synchronize any results of the procedures from computing devices 16, 18 to PPEMS 6.

Further, as described herein, PPEMS 6 integrates an event processing platform configured to process thousand or even millions of concurrent streams of events from digitally enabled PPEs, such as respirators 13. In some examples, events may include queries to or responses from safety assistants. An underlying analytics engine of PPEMS 6 applies historical data and models to the inbound streams to compute assertions, such as identified anomalies or predicted occurrences of safety events based on conditions or behavior patterns of workers 10, including queries to or responses from safety assistants. Further, PPEMS 6 provides real-time alerting and reporting to notify workers 10 and/or workers 20, 24 of any predicted events, anomalies, trends, and the like.

The analytics engine of PPEMS 6 may, in some examples, apply analytics to identify relationships or correlations between one or more of queries to or responses from safety assistants, sensed worker data, environmental conditions, geographic regions and/or other factors and analyze the impact on safety events. PPEMS 6 may determine, based on the data acquired across populations of workers 10, which particular activities, possibly within certain geographic region, lead to, or are predicted to lead to, unusually high occurrences of safety events.

In this way, PPEMS 6 tightly integrates comprehensive tools for managing personal protection equipment with an underlying analytics engine and communication system to provide data acquisition, monitoring, activity logging, reporting, behavior analytics and alert generation. Moreover, PPEMS 6 provides a communication system for operation and utilization by and between the various elements of system 2. Workers 20, 24 may access PPEMS 6 to view results on any analytics performed by PPEMS 6 on data acquired from workers 10. In some examples, PPEMS 6 may present a web-based interface via a web server (e.g., an HTTP server) or client-side applications may be deployed for devices of computing devices 16, 18 used by workers 20, 24, such as desktop computers, laptop computers, mobile devices such as smartphones and tablets, or the like.

In some examples, PPEMS 6 may provide a database query engine for directly querying PPEMS 6 to view acquired safety information, compliance information, queries to or responses from safety assistants, and any results of the analytic engine, e.g., by the way of dashboards, alert notifications, reports and the like. That is, workers 24, 26, or software executing on computing devices 16, 18, may submit queries to PPEMS 6 and receive data corresponding to the queries for presentation in the form of one or more reports or dashboards. Such dashboards may provide various insights regarding system 2, such as baseline (“normal”) operation across worker populations, identifications of any anomalous workers engaging in abnormal activities that may potentially expose the worker to risks, identifications of any geographic regions within environments 8 for which unusually anomalous (e.g., high) safety events have been or are predicted to occur, queries to or responses from safety assistants, identifications of any of environments 8 exhibiting anomalous occurrences of safety events relative to other environments, and the like.

As illustrated in detail below, PPEMS 6 may simplify workflows for individuals charged with monitoring and ensure safety compliance for an entity or environment. That is, the techniques of this disclosure may enable active safety management and allow an organization to take preventative or correction actions with respect to certain regions within environments 8, queries to or responses from safety assistants, particular pieces of safety equipment or individual workers 10, and/or may further allow the entity to implement workflow procedures that are data-driven by an underlying analytical engine.

As one example, the underlying analytical engine of PPEMS 6 may be configured to compute and present customer-defined metrics for worker populations within a given environment 8 or across multiple environments for an organization as a whole. For example, PPEMS 6 may be configured to acquire data, including but not limited to queries to or responses from safety assistants, and provide aggregated performance metrics and predicted behavior analytics across a worker population (e.g., across workers 10 of either or both of environments 8A, 8B). Furthermore, workers 20, 24 may set benchmarks for occurrence of any safety incidences, and PPEMS 6 may track actual performance metrics relative to the benchmarks for individuals or defined worker populations. As another example, PPEMS 6 may further trigger an alert if certain combinations of conditions and/or events are present, such as based on queries to or responses from safety assistants. In this manner, PPEMS 6 may identify PPE, environmental characteristics and/or workers 10 for which the metrics do not meet the benchmarks and prompt the workers to intervene and/or perform procedures to improve the metrics relative to the benchmarks, thereby ensuring compliance and actively managing safety for workers 10.

FIG. 1 is directed to a system 2 that may improve worker safety by applying safety context data (e.g., characterizing at least one of the worker, a worker environment, or PPE) in natural language processing of utterances from worker 10N to generate an output that is semantically responsive to an expression of worker 10N about the safety event. Worker 10N who engages in activities in work environment 8B may be exposed to different hazards, require certain types of PPE 13N or proper fit of PPE 13N, or require information relating to situational awareness of worker 10N, PPE 13N of worker 10N, and/or work environment 8B of worker 10N, to name only a few examples. Because workers 10 may be subjected to complex tasks, dangerous situations, or strenuous physical activities, quickly and safely obtaining information about safety events that are of relevance to worker 10N may be difficult or not possible. While some conventional systems may rely on a worker's pre-existing knowledge of pre-defined commands that have specific meaning to a computing device, such conventional systems may be difficult for a worker to use because the worker may not remember or correctly pronounce such pre-defined commands, particularly under challenging work conditions. Furthermore, because a single concept in a spoken language may be represented with alternative words (e.g., “automobile”, “car”, “vehicle”), a worker may express a request for information using an alternative word for a pre-defined command that is not recognized by the system. As such, a worker in need of information that is timely, relevant, and responsive to a verbal expression of the worker may experience difficulty, or altogether avoid, using pre-defined command systems. Pre-defined command systems may also fail to use contextual data (e.g., characterizing at least one of the worker, a worker environment, or PPE) to improve the relevance of any output that is semantically responsive to the expression of the worker about the safety event. Pre-defined command systems may also include limitations that only permit queries for a single entity, such as a work environment, rather than permitting complex queries with multiple entities such as “are all the workers in my work environment protected by the correct types of PPE”.

Rather than using pre-defined commands in the absence of contextual data, system 2 may apply natural language processing to set of worker utterances in conjunction with safety context data to increase the relevance of one or more computer-generated responses that are semantically responsive to the initial verbal expression of worker 10N about the safety event. Because techniques of this disclosure apply natural language processing to set of worker utterances in conjunction with safety context data to generate responses, worker 10N may speak in his or her own familiar and personal style to receive computer-generated responses that are semantically responsive to the expression of worker 10N about the safety event. In this way, techniques of this disclosure may reduce the amount of worker effort to request information verbally and receive audible responses and may increase the likelihood that worker 10N initiates requests for information about safety events. Consequently, techniques of this disclosure may improve worker safety by simplifying the audio worker interface through which worker 10N sends and receives information about safety events.

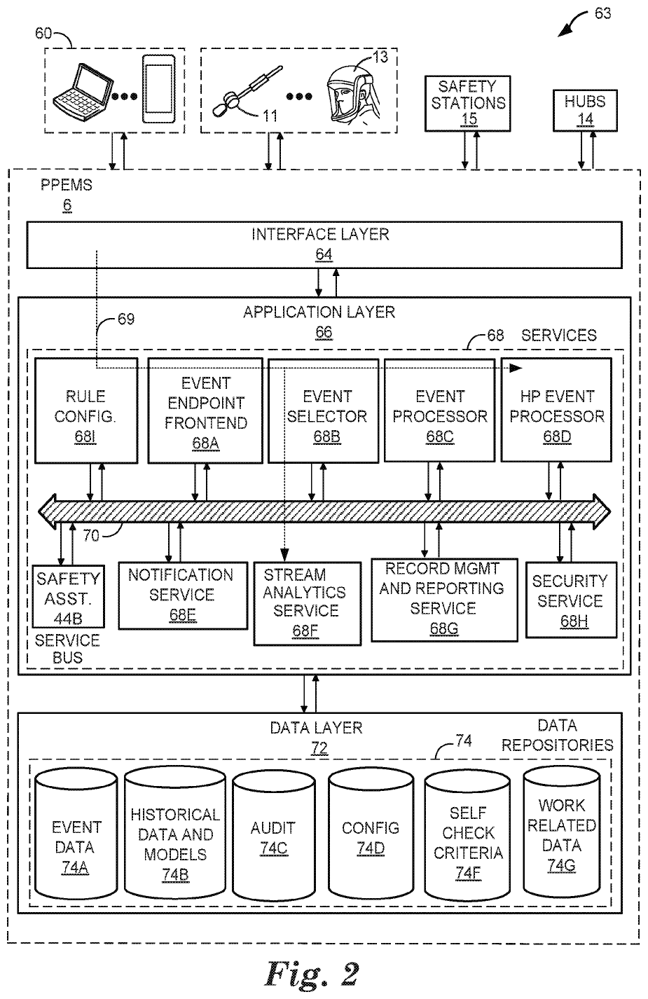

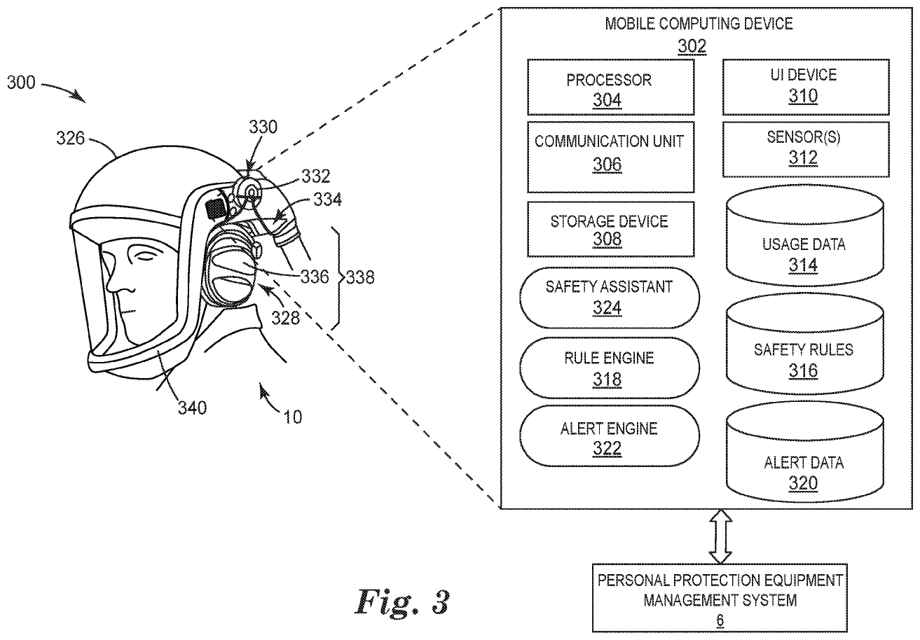

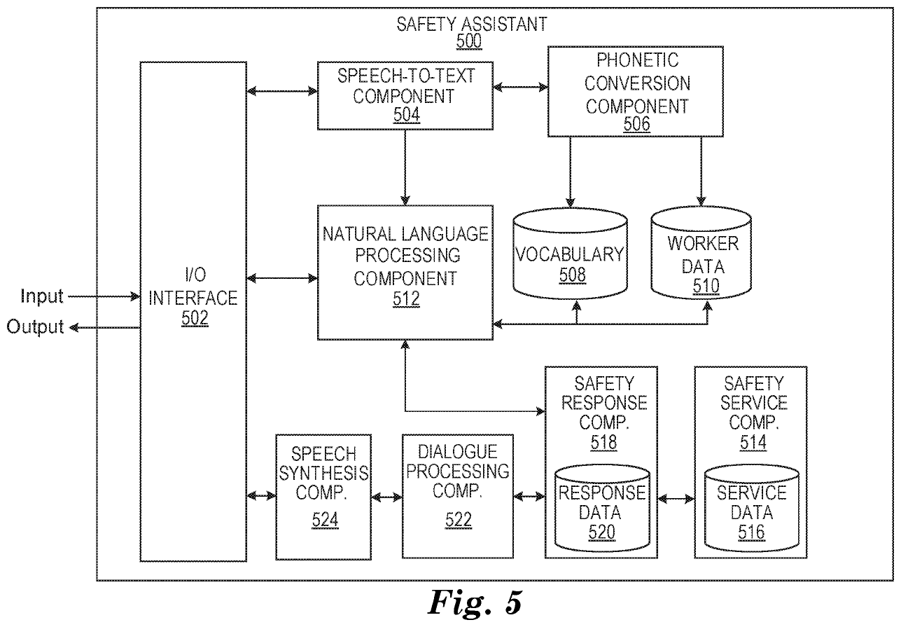

In the example of system 2, data hub 14N, PPEMS 6, safety stations 15, and/or any other computing device may implement a safety assistant, as further described in this disclosure. For example purposes in FIG. 1, the safety assistant is described as being implemented in data hub 14N. The safety assistant may be implemented as a combination of hardware and/or software in one or more computing devices. For example purposes, the safety assistant implemented in data hub 14N may be an example of safety assistant 68J of FIG. 2, safety assistant 324 of FIG. 3, or safety assistant 500 in FIG. 5. In other examples, the safety assistant may be implemented in other devices such as physical integrated or attached to PPE 13N.

In the example of FIG. 1, data hub 14N may receive audio data that represents a set of utterances from worker 10N. The audio data may be generated by a microphone or other sensor positioned or integrated at the headtop of PPE 13N. The set of utterances may represent at least one expression of worker 10N about a safety event. In some examples, an utterance may be any spoken word, statement, or vocal sound. For instance, the set of utterances may represent the sentence “Are all workers nearby protected by the right PPE?”.

The safety assistant implemented at data hub 14N may select a set of safety context data that characterizes at least one of the worker, a worker environment, or an article of personal protection equipment. In some examples, the safety context data may be from one or more sensors configured at PPE 13, workers 10, sensing stations 21, safety stations 15, beacons 17 or any other sensors in one or more environments 8. In some examples, the safety context data may be from PPEMS 6, computing devices 18, computing devices 16, or any other computing devices.

In accordance with techniques of this disclosure, the safety assistant implemented at data hub 14N may generate, based at least in part on the safety context data and applying natural language processing to the utterances of worker 10N, safety response data. In some examples, safety response data represents a set of utterances that is semantically responsive to the expression of worker 10N about the safety event. For example, the set of utterances may be machine-generated by the safety assistant as further described in FIG. 5. In the example of FIG. 1, the set of utterances generated by the safety assistant implemented at data hub 14N may include the affirmative statement “YES”. The safety response data may be determined based on the safety assistant performing natural language processing on the set of utterances of worker 10N with safety context data about work environment 8B, the locations of other workers 10A-10B, the types of PPE 13A-13B, the hazards detected by sensing stations 21, the configurations of PPE 13A-13B, and any other safety context data that may be usable by the safety assistant to generate the set of utterances that is semantically responsive to the expression of worker 10N about the safety event. Although safety response data is described in FIG. 1 as a set of utterances that is semantically responsive to the expression of worker 10N about the safety event, in other examples as described in this disclosure, safety response data may include any operations and/or data that may be in response to the expression of worker 10N about the safety event.

Data hub 14N may generate one or more outputs based at least in part on the safety response data that represents a set of utterances that is semantically responsive to the expression of the worker about the safety event. In some examples, the output may be visual, audible, haptic, or otherwise sensory to a human. In some examples, the output may be a report, message sent to another computing device, or a file or other structured data that is stored, modified, or transferred. In the example of FIG. 1, the generated output based on the safety response data is an audio output indicating “YES” in response to the input from worker 10N “Are all workers nearby protected by the right PPE?”. Using techniques of this disclosure, a worker may submit input to the safety assistant comprising complex queries with multiple entities such as “are all the workers in my work environment protected by the correct types of PPE” and receive output that is semantically responsive to the expression of worker 10N.

Further details of the techniques and systems of this disclosure are described with respect to the following FIGS. and corresponding descriptions.

FIG. 2 is a block diagram illustrating an operating perspective of the personal protection equipment management system shown in FIG. 1 in accordance with various techniques of this disclosure. FIG. 2 provides an operating perspective of PPEMS 6 when hosted as cloud-based platform capable of supporting multiple, distinct work environments 8 having an overall population of workers 10 that have a variety of communication enabled personal protection equipment (PPE), such as safety release lines (SRLs) 11, respirators 13, safety helmets, safety assistants, hearing protection, or other safety equipment. In the example of FIG. 2, the components of PPEMS 6 are arranged according to multiple logical layers that implement the techniques of the disclosure. Each layer may be implemented by a one or more modules comprised of hardware, software, or a combination of hardware and software.

In FIG. 2, personal protection equipment (PPEs) 62, such as SRLs 11, respirators 13 and/or other equipment, either directly or by way of hubs 14, as well as computing devices 60, operate as clients 63 that communicate with PPEMS 6 via interface layer 64. Computing devices 60 typically execute client software applications, such as desktop applications, mobile applications, and web applications. Computing devices 60 may represent any of computing devices 16, 18 of FIG. 1. Examples of computing devices 60 may include but are not limited to a portable or mobile computing device (e.g., smartphone, wearable computing device, tablet), laptop computers, desktop computers, smart television platforms, and servers, to name only a few examples.

As further described in this disclosure, PPEs 62 communicate with PPEMS 6 (directly or via hubs 14) using streams of data, including queries and responses for safety assistants, acquired from embedded sensors and other monitoring circuitry and receive from PPEMS 6 alerts, configuration and other communications. Client applications executing on computing devices 60 may communicate with PPEMS 6 to send and receive information, including queries and responses for safety assistants, that is retrieved, stored, generated, and/or otherwise processed by services 68. For instance, the client applications may submit a query for a safety assistant or request and edit safety event information including analytical data stored at and/or managed by PPEMS 6. In some examples, client applications may request and display responses from safety assistants or aggregate safety event information that summarizes or otherwise aggregates numerous individual instances of safety events and corresponding data acquired from PPEs 62 and or generated by PPEMS 6. The client applications may interact with PPEMS 6 to query for analytics information about past and predicted safety events, behavior trends of workers 10, and queries and responses for safety assistants, to name only a few examples. In some examples, the client applications may output for display information received from PPEMS 6 to visualize such information for workers of clients 63. As further illustrated and described in below, PPEMS 6 may provide information to the client applications, which the client applications output for display in worker interfaces.

Clients applications executing on computing devices 60, 63, and/or PPE 62 may be implemented for different platforms but include similar or the same functionality. For instance, a client application may be a desktop application compiled to run on a desktop operating system, such as Microsoft Windows, Apple OS X, or Linux, to name only a few examples. As another example, a client application may be a mobile application compiled to run on a mobile operating system, such as Google Android, Apple iOS, Microsoft Windows Mobile, or BlackBerry OS to name only a few examples. As another example, a client application may be a web application such as a web browser that displays web pages received from PPEMS 6. In the example of a web application, PPEMS 6 may receive requests from the web application (e.g., the web browser), process the requests, and send one or more responses back to the web application. In this way, the collection of web pages, the client-side processing web application, and the server-side processing performed by PPEMS 6 collectively provides the functionality to perform techniques of this disclosure. In this way, client applications use various services of PPEMS 6 in accordance with techniques of this disclosure, and the applications may operate within various different computing environment (e.g., embedded circuitry or processor of a PPE, a desktop operating system, mobile operating system, or web browser, to name only a few examples).

As shown in FIG. 2, PPEMS 6 includes an interface layer 64 that represents a set of application programming interfaces (API) or protocol interface presented and supported by PPEMS 6. Interface layer 64 initially receives messages from any of clients 63 for further processing at PPEMS 6. Interface layer 64 may therefore provide one or more interfaces that are available to client applications executing on clients 63. In some examples, the interfaces may be application programming interfaces (APIs) that are accessible over a network. Interface layer 64 may be implemented with one or more web servers. The one or more web servers may receive incoming requests, process and/or forward information from the requests to services 68, and provide one or more responses, based on information received from services 68, to the client application that initially sent the request. In some examples, the one or more web servers that implement interface layer 64 may include a runtime environment to deploy program logic that provides the one or more interfaces. As further described below, each service may provide a group of one or more interfaces that are accessible via interface layer 64.

In some examples, interface layer 64 may provide Representational State Transfer (RESTful) interfaces that use HTTP methods to interact with services and manipulate resources of PPEMS 6. In such examples, services 68 may generate JavaScript Object Notation (JSON) messages that interface layer 64 sends back to the client application that submitted the initial request. In some examples, interface layer 64 provides web services using Simple Object Access Protocol (SOAP) to process requests from client applications. In still other examples, interface layer 64 may use Remote Procedure Calls (RPC) to process requests from clients 63. Upon receiving a request from a client application to use one or more services 68, interface layer 64 sends the information to application layer 66, which includes services 68.

As shown in FIG. 2, PPEMS 6 also includes an application layer 66 that represents a collection of services for implementing much of the underlying operations of PPEMS 6. Application layer 66 receives information included in requests received from client applications and further processes the information according to one or more of services 68 invoked by the requests. Application layer 66 may be implemented as one or more discrete software services executing on one or more application servers, e.g., physical or virtual machines. That is, the application servers provide runtime environments for execution of services 68. In some examples, the functionality interface layer 64 as described above and the functionality of application layer 66 may be implemented at the same server.

Application layer 66 may include one or more separate software services 68, e.g., processes that communicate, e.g., via a logical service bus 70 as one example. Service bus 70 generally represents a logical interconnections or set of interfaces that allows different services to send messages to other services, such as by a publish/subscription communication model. For instance, each of services 68 may subscribe to specific types of messages based on criteria set for the respective service. When a service publishes a message of a particular type on service bus 70, other services that subscribe to messages of that type will receive the message. In this way, each of services 68 may communicate information to one another. As another example, services 68 may communicate in point-to-point fashion using sockets or other communication mechanism. Before describing the functionality of each of services 68, the layers are briefly described herein.

Data layer 72 of PPEMS 6 represents a data repository that provides persistence for information in PPEMS 6 using one or more data repositories 74. A data repository, generally, may be any data structure or software that stores and/or manages data. Examples of data repositories include but are not limited to relational databases, multi-dimensional databases, maps, and hash tables, to name only a few examples. Data layer 72 may be implemented using Relational Database Management System (RDBMS) software to manage information in data repositories 74. The RDBMS software may manage one or more data repositories 74, which may be accessed using Structured Query Language (SQL). Information in the one or more databases may be stored, retrieved, and modified using the RDBMS software. In some examples, data layer 72 may be implemented using an Object Database Management System (ODBMS), Online Analytical Processing (OLAP) database or other suitable data management system.

As shown in FIG. 2, each of services 68A-68J (“services 68”) is implemented in a modular form within PPEMS 6. Although shown as separate modules for each service, in some examples the functionality of two or more services may be combined into a single module or component. Each of services 68 may be implemented in software, hardware, or a combination of hardware and software. Moreover, services 68 may be implemented as standalone devices, separate virtual machines or containers, processes, threads or software instructions generally for execution on one or more physical processors.

In some examples, one or more of services 68 may each provide one or more interfaces that are exposed through interface layer 64. Accordingly, client applications of computing devices 60 may call one or more interfaces of one or more of services 68 to perform techniques of this disclosure.

Services 68 may include an event processing platform including an event endpoint frontend 68A, event selector 68B, event processor 68C and high priority (HP) event processor 68D. Event endpoint frontend 68A operates as a front end interface for receiving and sending communications to PPEs 62 and hubs 14. In other words, event endpoint frontend 68A operates to as a front line interface to safety equipment deployed within environments 8 and utilized by workers 10. In some instances, event endpoint frontend 68A may be implemented as a plurality of tasks or jobs spawned to receive individual inbound communications of event streams 69 from the PPEs 62 carrying data sensed and captured by the safety equipment. When receiving event streams 69, for example, event endpoint frontend 68A may spawn tasks to quickly enqueue an inbound communication, referred to as an event, and close the communication session, thereby providing high-speed processing and scalability. Each incoming communication may, for example, carry data recently captured data representing sensed conditions, motions, temperatures, actions or other data, generally referred to as events. Communications exchanged between the event endpoint frontend 68A and the PPEs may be real-time or pseudo real-time depending on communication delays and continuity.

Event selector 68B operates on the stream of events 69 received from PPEs 62 and/or hubs 14 via frontend 68A and determines, based on rules or classifications, priorities associated with the incoming events. For instance, a query to a safety assistant with an higher priority may be routed by high priority event processor 68D in accordance with the query priority. Based on the priorities, event selector 68B enqueues the events for subsequent processing by event processor 68C or high priority (HP) event processor 68D. Additional computational resources and objects may be dedicated to HP event processor 68D so as to ensure responsiveness to critical events, such as incorrect usage of PPEs, use of incorrect filters and/or respirators based on geographic locations and conditions, failure to properly secure SRLs 11 and the like. Responsive to processing high priority events, HP event processor 68D may immediately invoke notification service 68E to generate alerts, instructions, warnings, responses, or other similar messages to be output to SRLs 11, respirators 13, hubs 14 and/or remote workers 20, 24. Events not classified as high priority are consumed and processed by event processor 68C.

In general, event processor 68C or high priority (HP) event processor 68D operate on the incoming streams of events to update event data 74A within data repositories 74. In general, event data 74A may include all or a subset of usage data obtained from PPEs 62. For example, in some instances, event data 74A may include entire streams of samples of data obtained from electronic sensors of PPEs 62. In other instances, event data 74A may include a subset of such data, e.g., associated with a particular time period or activity of PPEs 62.

Event processors 68C, 68D may create, read, update, and delete event information stored in event data 74A. Event information may be stored in a respective database record as a structure that includes name/value pairs of information, such as data tables specified in row/column format. For instance, a name (e.g., column) may be “worker ID” and a value may be an employee identification number. An event record may include information such as, but not limited to: worker identification, PPE identification, acquisition timestamp(s) and data indicative of one or more sensed parameters.

In addition, event selector 68B directs the incoming stream of events to stream analytics service 68F, which is configured to perform in depth processing of the incoming stream of events to perform real-time analytics. Stream analytics service 68F may, for example, be configured to process and compare multiple streams of event data 74A with historical data and models 74B in real-time as event data 74A is received. In this way, stream analytic service 68D may be configured to detect anomalies, transform incoming event data values, trigger alerts upon detecting safety concerns based on conditions or worker behaviors. Historical data and models 74B may include, for example, specified safety rules, business rules and the like. In addition, stream analytic service 68F may generate output for communicating to PPPEs 62 by notification service 68E or computing devices 60 by way of record management and reporting service 68G. In some examples, events processed by event processors 68C-68D may be safety events or may be events other than safety events.

In this way, analytics service 68F processes inbound streams of events, potentially hundreds or thousands of streams of events, from enabled safety PPEs 62 utilized by workers 10 within environments 8 to apply historical data and models 74B to compute assertions, such as identified anomalies or predicted occurrences of imminent safety events based on conditions or behavior patterns of the workers. Analytics service may 68F publish responses, messages, or assertions to notification service 68E and/or record management by service bus 70 for output to any of clients 63.

In this way, analytics service 68F may be configured as an active safety management system that predicts imminent safety concerns, responds to queries for safety assistants, and provides real-time alerting and reporting. In addition, analytics service 68F may be a decision support system that provides techniques for processing inbound streams of event data to generate assertions in the form of statistics, conclusions, and/or recommendations on an aggregate or individualized worker and/or PPE basis for enterprises, safety officers and other remote workers. For instance, analytics service 68F may apply historical data and models 74B to determine, for a particular worker or query or response to a safety assistant, the likelihood that a safety event is imminent for the worker based on detected behavior or activity patterns, environmental conditions and geographic locations. In some examples, analytics service 68F may determine, such as based on a query or response for a safety assistant, whether a worker is currently impaired, e.g., due to exhaustion, sickness or alcohol/drug use, and may require intervention to prevent safety events. As yet another example, analytics service 68F may provide comparative ratings of workers or type of safety equipment in a particular environment 8, such as based on a query or response for a safety assistant.

Hence, analytics service 68F may maintain or otherwise use one or more models that provide risk metrics to predict safety events. Analytics service 68F may also generate order sets, recommendations, and quality measures. In some examples, analytics service 68F may generate worker interfaces based on processing information stored by PPEMS 6 to provide actionable information to any of clients 63. For example, analytics service 68F may generate dashboards, alert notifications, reports and the like for output at any of clients 63. Such information may provide various insights regarding baseline (“normal”) operation across worker populations, identifications of any anomalous workers engaging in abnormal activities that may potentially expose the worker to risks, identifications of any geographic regions within environments for which unusually anomalous (e.g., high) safety events have been or are predicted to occur, identifications of any of environments exhibiting anomalous occurrences of safety events relative to other environments, and the like, any of a which may be based on queries or responses for a safety assistant.

Although other technologies can be used, in one example implementation, analytics service 68F utilizes machine learning when operating on streams of safety events so as to perform real-time analytics. That is, analytics service 68F includes executable code generated by application of machine learning to training data of event streams and known safety events to detect patterns, such as based on a query or response for a safety assistant. The executable code may take the form of software instructions or rule sets and is generally referred to as a model that can subsequently be applied to event streams 69 for detecting similar patterns, predicting upcoming events, or the like.

Analytics service 68F may, in some examples, generate separate models for a particular worker, a particular population of workers, a particular or generalized query or response for a safety assistant, a particular environment, or combinations thereof. Analytics service 68F may update the models based on usage data received from PPEs 62. For example, analytics service 68F may update the models for a particular worker, particular or generalized query or response for a safety assistant, a particular population of workers, a particular environment, or combinations thereof based on data received from PPEs 62. In some examples, usage data may include incident reports, air monitoring systems, manufacturing production systems, or any other information that may be used to a train a model.

Alternatively, or in addition, analytics service 68F may communicate all or portions of the generated code and/or the machine learning models to hubs 14 (or PPEs 62) for execution thereon so as to provide local alerting in near-real time to PPEs. Example machine learning techniques that may be employed to generate models 74B can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LUQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Record management and reporting service 68G processes and responds to messages and queries received from computing devices 60 via interface layer 64. For example, record management and reporting service 68G may receive requests from client computing devices for event data related to individual workers, populations or sample sets of workers, geographic regions of environments 8 or environments 8 as a whole, individual or groups/types of PPEs 62. In response, record management and reporting service 68G accesses event information based on the request. Upon retrieving the event data, record management and reporting service 68G constructs an output response to the client application that initially requested the information. In some examples, the data may be included in a document, such as an HTML document, or the data may be encoded in a JSON format or presented by a dashboard application executing on the requesting client computing device. For instance, as further described in this disclosure, example worker interfaces that include the event information are depicted in the figures.

As additional examples, record management and reporting service 68G may receive requests to find, analyze, and correlate PPE event information, including queries or responses for a safety assistant. For instance, record management and reporting service 68G may receive a query request from a client application for event data 74A over a historical time frame, such as a worker can view PPE event information over a period of time and/or a computing device can analyze the PPE event information over the period of time.

In example implementations, services 68 may also include security service 68H that authenticate and authorize workers and requests with PPEMS 6. Specifically, security service 68H may receive authentication requests from client applications and/or other services 68 to access data in data layer 72 and/or perform processing in application layer 66. An authentication request may include credentials, such as a worker name and password. Security service 68H may query security data to determine whether the worker name and password combination is valid. Configuration data 74D may include security data in the form of authorization credentials, policies, and any other information for controlling access to PPEMS 6. As described above, security data may include authorization credentials, such as combinations of valid worker names and passwords for authorized workers of PPEMS 6. Other credentials may include device identifiers or device profiles that are allowed to access PPEMS 6.

Security service 68H may provide audit and logging functionality for operations performed at PPEMS 6. For instance, security service 68H may log operations performed by services 68 and/or data accessed by services 68 in data layer 72, including queries or responses for a safety assistant. Security service 68H may store audit information such as logged operations, accessed data, and rule processing results in audit data 74C. In some examples, security service 68H may generate events in response to one or more rules being satisfied. Security service 68H may store data indicating the events in audit data 74C.

In the example of FIG. 2, a safety manager may initially configure one or more safety rules. As such, remote worker 24 may provide one or more worker inputs at computing device 18 that configure a set of safety rules for work environment 8A and 8B. For instance, a computing device 60 of the safety manager may send a message that defines or specifies the safety rules. Such message may include data to select or create conditions and actions of the safety rules. PPEMS 6 may receive the message at interface layer 64 which forwards the message to rule configuration component 68I. Rule configuration component 68I may be combination of hardware and/or software that provides for rule configuration including, but not limited to: providing a worker interface to specify conditions and actions of rules, receive, organize, store, and update rules included in a safety rules data store (not shown).

The safety rules data store may be a data store that includes data representing one or more safety rules. The safety rules data store may be any suitable data store such as a relational database system, online analytical processing database, object-oriented database, or any other type of data store. When rule configuration component 68I receives data defining safety rules from computing device 60 of the safety manager, rule configuration component 68I may store the safety rules in the safety rules data store.

In some examples, storing the safety rules may include associating a safety rule with context data, such that rule configuration component 68I may perform a lookup to select safety rules associated with matching context data. Context data may include any data describing or characterizing the properties or operation a worker, worker environment, article of PPE, or any other entity, including queries or responses for a safety assistant. Context data of a worker may include, but is not limited to: a unique identifier of a worker, type of worker, role of worker, physiological or biometric properties of a worker, experience of a worker, training of a worker, time worked by a worker over a particular time interval, location of the worker, or any other data that describes or characterizes a worker, including content of queries or responses for a safety assistant. Context data of an article of PPE may include, but is not limited to: a unique identifier of the article of PPE; a type of PPE of the article of PPE; a usage time of the article of PPE over a particular time interval; a lifetime of the PPE; a component included within the article of PPE; a usage history across multiple workers of the article of PPE; contaminants, hazards, or other physical conditions detected by the PPE, expiration date of the article of PPE; operating metrics of the article of PPE. Context data for a work environment may include, but is not limited to: a location of a work environment, a boundary or perimeter of a work environment, an area of a work environment, hazards within a work environment, physical conditions of a work environment, permits for a work environment, equipment within a work environment, owner of a work environment, responsible supervisor and/or safety manager for a work environment.

According to aspects of this disclosure, the rules and/or context data may be used for purposes of reporting, to generate alerts, generating responses from a safety assistant, or the like. In an example for purposes of illustration, worker 10A may be equipped with respirator 13A and data hub 14A. Respirator 13A may include a filter to remove particulates but not organic vapors. Data hub 14A may be initially configured with and store a unique identifier of worker 10A. When initially assigning the respirator 13A and data hub to worker 10A, a computing device operated by worker 10A and/or a safety manager may cause RMRS 68G to store a mapping in work relation data 74G. Work relation data 74G may include mappings between data that corresponds to PPE, workers, and work environments. Work relation data 74G may be any suitable datastore for storing, retrieving, updating and deleting data. RMRS 68G may store a mapping between the unique identifier of worker 10A and a unique device identifier of data hub 14A. Work relation data store 74G may also map a worker to an environment.

Worker 10A may initially put on respirator 13A and data hub 14A prior to entering environment 8A. As worker 10A approaches environment 8A and/or has entered environment 8A, data hub 14A may determine that worker 10A is within a threshold distance of entering environment 8A or has entered environment 8A. Data hub 14A may determine that it is within a threshold distance of entering environment 8A or has entered environment 8A and send a message that includes context data to PPEMS 6 that indicates data hub 14A is within a threshold distance of entering environment 8A.

In some examples, PPEMS 6 may additionally or alternatively apply analytics to predict the likelihood of a safety event. As noted above, a safety event may refer to activities of a worker 10 using PPE 62, queries or responses for a safety assistant, a condition of PPE 62, or a hazardous environmental condition (e.g., that the likelihood of a safety event is relatively high, that the environment is dangerous, that SRL 11 is malfunctioning, that one or more components of SRL 11 need to be repaired or replaced, or the like). For example, PPEMS 6 may determine the likelihood of a safety event based on application of usage data from PPE 62 and/or queries or responses for a safety assistant to historical data and models 74B. That is, PEMS 6 may apply historical data and models 74B to usage data from respirators 13 and/or queries or responses for a safety assistant in order to compute assertions, such as anomalies or predicted occurrences of imminent safety events based on environmental conditions or behavior patterns of a worker using a respirator 13.

PPEMS 6 may apply analytics to identify relationships or correlations between sensed data from respirators 13, queries or responses for a safety assistant, environmental conditions of environment in which respirators 13 are located, a geographic region in which respirators 13 are located, and/or other factors. PPEMS 6 may determine, based on the data acquired across populations of workers 10, which particular activities, possibly within certain environment or geographic region, lead to, or are predicted to lead to, unusually high occurrences of safety events. PPEMS 6 may generate alert data based on the analysis of the usage data and transmit the alert data to PPEs 62 and/or hubs 14. Hence, according to aspects of this disclosure, PPEMS 6 may determine usage data of respirator 13, generate status indications, determine performance analytics, and/or perform prospective/preemptive actions based on a likelihood of a safety event, which may be based on queries or responses for a safety assistant.

Usage data from respirators 13 and/or queries or responses for a safety assistant may be used to determine usage statistics. For example, PPEMS 6 may determine, based on usage data from respirators 13 or a safety assistant, a length of time that one or more components of respirator 13 (e.g., head top, blower, and/or filter) have been in use, an instantaneous velocity or acceleration of worker 10 (e.g., based on an accelerometer included in respirators 13 or hubs 14), a temperature of one or more components of respirator 13 and/or worker 10, a location of worker 10, a number of times or frequency with which a worker 10 has performed a self-check of respirator 13 or other PPE, a number of times or frequency with which a visor of respirator 13 has been opened or closed, a filter/cartridge consumption rate, fan/blower usage (e.g., time in use, speed, or the like), battery usage (e.g., charge cycles), or the like.

PPEMS 6 may use the usage data to characterize activity of worker 10. For example, PPEMS 6 may establish patterns of productive and nonproductive time (e.g., based on operation of respirator 13 and/or movement of worker 10), categorize worker movements, identify key motions, and/or infer occurrence of key events, which may be based on queries or responses for a safety assistant. That is, PPEMS 6 may obtain the usage data, analyze the usage data using services 68 (e.g., by comparing the usage data to data from known activities/events), and generate an output based on the analysis, such as by using queries or responses for a safety assistant.

One or more of the examples in this disclosure may use usage statistics and/or usage data that includes or is based on queries or responses for a safety assistant. In some examples, the usage statistics may be used to determine when respirator 13 is in need of maintenance or replacement. For example, PPEMS 6 may compare the usage data to data indicative of normally operating respirators 13 in order to identify defects or anomalies. In other examples, PPEMS 6 may also compare the usage data to data indicative of a known service life statistics of respirators 13. The usage statistics may also be used to provide an understanding how respirators 13 are used by workers 10 to product developers in order to improve product designs and performance. In still other examples, the usage statistics may be used to gather human performance metadata to develop product specifications. In still other examples, the usage statistics may be used as a competitive benchmarking tool. For example, usage data may be compared between customers of respirators 13 to evaluate metrics (e.g. productivity, compliance, or the like) between entire populations of workers outfitted with respirators 13.

Usage data from respirators 13 may be used to determine status indications. For example, PPEMS 6 may determine that a visor of a respirator 13 is up in hazardous work area. PPEMS 6 may also determine that a worker 10 is fitted with improper equipment (e.g., an improper filter for a specified area), or that a worker 10 is present in a restricted/closed area. PPEMS 6 may also determine whether worker temperature exceeds a threshold, e.g., in order to prevent heat stress. PPEMS 6 may also determine when a worker 10 has experienced an impact, such as a fall.

Usage data from respirators 13 may be used to assess performance of worker 10 wearing respirator 13. For example, PPEMS 6 may, based on usage data from respirators 13, recognize motion that may indicate a pending fall by worker 10 (e.g., via one or more accelerometers included in respirators 13 and/or hubs 14). In some instances, PPEMS 6 may, based on usage data from respirators 13, infer that a fall has occurred or that worker 10 is incapacitated. PPEMS 6 may also perform fall data analysis after a fall has occurred and/or determine temperature, humidity and other environmental conditions as they relate to the likelihood of safety events.

As another example, PPEMS 6 may, based on usage data from respirators 13, recognize motion that may indicate fatigue or impairment of worker 10. For example, PPEMS 6 may apply usage data from respirators 13 to a safety learning model that characterizes a motion of a worker of at least one respirator. In this example, PPEMS 6 may determine that the motion of a worker 10 over a time period is anomalous for the worker 10 or a population of workers 10 using respirators 13.

Usage data from respirators 13 may be used to determine alerts and/or actively control operation of respirators 13. For example, PPEMS 6 may determine that a safety event such as equipment failure, a fall, or the like is imminent. PPEMS 6 may send data to respirators 13 to change an operating condition of respirators 13. In an example for purposes of illustration, PPEMS 6 may apply usage data to a safety learning model that characterizes an expenditure of a filter of one of respirators 13. In this example, PPEMS 6 may determine that the expenditure is higher than an expected expenditure for an environment, e.g., based on conditions sensed in the environment, usage data gathered from other workers 10 in the environment, or the like. PPEMS 6 may generate and transmit an alert to worker 10 that indicates that worker 10 should leave the environment and/or active control of respirator 13. For example, PPEMS 6 may cause respirator to reduce a blower speed of a blower of respirator 13 in order to provide worker 10 with substantial time to exit the environment.

PPEMS 6 may generate, in some examples, a warning when worker 10 is near a hazard in one of environments 8 (e.g., based on location data gathered from a location sensor (GPS or the like) of respirators 13). PPEMS 6 may also applying usage data to a safety learning model that characterizes a temperature of worker 10. In this example, PPEMS 6 may determine that the temperature exceeds a temperature associated with safe activity over the time period and alert worker 10 to the potential for a safety event due to the temperature.

In another example, PPEMS 6 may schedule preventative maintenance or automatically purchase components for respirators 13 based on usage data. For example, PPEMS 6 may determine a number of hours a blower of a respirator 13 has been in operation, and schedule preventative maintenance of the blower based on such data. PPEMS 6 may automatically order a filter for respirator 13 based on historical and/or current usage data from the filter.

Again, PPEMS 6 may determine the above-described performance characteristics and/or generate the alert data based on application of the usage data to one or more safety learning models that characterizes activity of a worker of one of respirators 13. The safety learning models may be trained based on historical data or known safety events. However, while the determinations are described with respect to PPEMS 6, as described in greater detail herein, one or more other computing devices, such as hubs 14 or respirators 13 may be configured to perform all or a subset of such functionality.

In some examples, a safety learning model is trained using supervised and/or reinforcement learning techniques. The safety learning model may be implemented using any number of models for supervised and/or reinforcement learning, such as but not limited to, an artificial neural networks, a decision tree, naïve Bayes network, support vector machine, or k-nearest neighbor model, to name only a few examples. In some examples, PPEMS 6 initially trains the safety learning model based on a training set of metrics and corresponding to safety events. In some examples, the training set may include or is based on queries or responses for a safety assistant. The training set may include a set of feature vectors, where each feature in the feature vector represents a value for a particular metric. As further example description, PPEMS 6 may select a training set comprising a set of training instances, each training instance comprising an association between usage data and a safety event. The usage data may comprise one or more metrics that characterize at least one of a worker, a work environment, or one or more articles of PPE. PPEMS 6 may, for each training instance in the training set, modify, based on particular usage data and a particular safety event of the training instance, the safety learning model to change a likelihood predicted by the safety learning model for the particular safety event in response to subsequent usage data applied to the safety learning model. In some examples, the training instances may be based on real-time or periodic data generated while PPEMS 6 managing data for one or more articles of PPE, workers, and/or work environments. As such, one or more training instances of the set of training instances may be generated from use of one or more articles of PPE after PPEMS 6 performs operations relating to the detection or prediction of a safety event for PPE, workers, and/or work environments that are currently in use, active, or in operation.

Some example metrics may include any characteristics or data described in this disclosure that relate to PPE, a worker, or a work environment, to name only a few examples. For instance, example metrics may include but are not limited to: worker identity, worker motion, worker location, worker age, worker experience, worker physiological parameters (e.g., heart rate, temperature, blood oxygen level, chemical compositions in blood, or any other measurable physiological parameter), queries or responses for a safety assistant or any other data descriptive of a worker or worker behavior. Example metrics may include but are not limited to: PPE type, PPE usage, PPE age, PPE operations, or any other data descriptive of PPE or PPE use. Example metrics may include but are not limited to: work environment type, work environment location, work environment temperature, work environment hazards, work environment size, or any other data descriptive of a work environment.

Each feature vector may also have a corresponding safety event. As described in this disclosure, a safety event may include but is not limited to: activities of a worker of personal protection equipment (PPE), a condition of the PPE, queries or responses for a safety assistant, or a hazardous environmental condition to name only a few examples. By training a safety learning model based on the training set, a safety learning model may be configured by PPEMS 6 to, when applying a particular feature vector to the safety learning model, generate higher probabilities or scores for safety events that correspond to training feature vectors that are more similar to the particular feature set. In the same way, the safety learning model may be configured by PPEMS 6 to, when applying a particular feature vector to the safety learning model, generate lower probabilities or scores for safety events that correspond to training feature vectors that are less similar to the particular feature set. Accordingly, the safety learning model may be trained, such that upon receiving a feature vector of metrics, the safety learning model may output one or more probabilities or scores that indicate likelihoods of safety events based on the feature vector. As such, PPEMS 6 may select likelihood of the occurrence as a highest likelihood of occurrence of a safety event in the set of likelihoods of safety events.

In some instances, PPEMS 6 may apply analytics for combinations of PPE. For example, PPEMS 6 may draw correlations between workers of respirators 13 and/or the other PPE (such as fall protection equipment, head protection equipment, hearing protection equipment, or the like) that is used with respirators 13. That is, in some instances, PPEMS 6 may determine the likelihood of a safety event based not only on usage data from respirators 13, but also from usage data from other PPE being used with respirators 13, which may include queries or responses for a safety assistant. In such instances, PPEMS 6 may include one or more safety learning models that are constructed from data of known safety events from one or more devices other than respirators 13 that are in use with respirators 13.

In some examples, a safety learning model is based on safety events from one or more of a worker, article of PPE, and/or work environment having similar characteristics (e.g., of a same type), which may include queries or responses for a safety assistant. In some examples the “same type” may refer to identical but separate instances of PPE. In other examples the “same type” may not refer to identical instances of PPE. For instance, although not identical, a same type may refer to PPE in a same class or category of PPE, same model of PPE, or same set of one or more shared functional or physical characteristics, to name only a few examples. Similarly, a same type of work environment or worker may refer to identical but separate instances of work environment types or worker types. In other examples, although not identical, a same type may refer to a worker or work environment in a same class or category of worker or work environment or same set of one or more shared behavioral, physiological, environmental characteristics, to name only a few examples.

In some examples, to apply the usage data to a model, PPEMS 6 may generate a structure, such as a feature vector, in which the usage data is stored. The feature vector may include a set of values that correspond to metrics (e.g., characterizing PPE, worker, work environment, queries or responses for a safety assistant, to name a few examples), where the set of values are included in the usage data. The model may receive the feature vector as input, and based on one or more relations defined by the model (e.g., probabilistic, deterministic or other functions within the knowledge of one of ordinary skill in the art) that has been trained, the model may output one or more probabilities or scores that indicate likelihoods of safety events based on the feature vector.

In general, while certain techniques or functions are described herein as being performed by certain components, e.g., PPEMS 6, respirators 13, or hubs 14, it should be understood that the techniques of this disclosure are not limited in this way. That is, certain techniques described herein may be performed by one or more of the components of the described systems. For example, in some instances, respirators 13 may have a relatively limited sensor set and/or processing power. In such instances, one of hubs 14 and/or PPEMS 6 may be responsible for most or all of the processing of usage data, determining the likelihood of a safety event, and the like. In other examples, respirators 13 and/or hubs 14 may have additional sensors, additional processing power, and/or additional memory, allowing for respirators 13 and/or hubs 14 to perform additional techniques. Determinations regarding which components are responsible for performing techniques may be based, for example, on processing costs, financial costs, power consumption, or the like. In other examples any functions described in this disclosure as being performed at one device (e.g., PPEMS 6, PPE 62, and/or computing devices 60, 63) may be performed at any other device (e.g., PPEMS 6, PPE 62, and/or computing devices 60, 63).

In the example of FIG. 2, safety assistant 68J may receive input from workers and determine safety response data that is semantically responsive to the expression of the worker. Safety assistant 68J may be an example of safety assistant 500 in FIG. 5. For example, safety assistant 68J may receive audio data via interface layer 64 that represents a set of utterances from a worker. The audio data may be generated by a microphone or other sensor positioned or integrated at PPE 13. The set of utterances may represent at least one expression of the worker. In some examples, an utterance may be any spoken word, statement, or vocal sound. For instance, the set of utterances may represent the sentence “Are all workers nearby protected by the right PPE?”.

Safety assistant 68J may select a set of safety context data that characterizes at least one of the worker, a worker environment, or an article of personal protection equipment. In some examples, the safety context data may be from one or more sensors configured at PPE, workers, sensing stations, safety stations, beacons or any other sensors in one or more environments. In some examples, the safety context data may be from PPEMS 6 or any other computing devices. In some examples, the safety context data may be from any of the data in data layer 72 and/or components in application layer 66.

In accordance with techniques of this disclosure, the safety assistant 68J implemented may determine, based at least in part on the safety context data and applying natural language processing to the utterances of the worker, safety response data. In some examples, safety response data represents a set of utterances that is semantically responsive to the expression of the worker. For example, the set of utterances may be machine-generated by safety assistant 68J as further described in FIG. 5. In the example of FIG. 2, the set of utterances generated by safety assistant 68J may include the statement “John is properly protected but Mike requires a fit test”. The response data may be generated based on the safety assistant performing natural language processing on the set of utterances of the worker with safety context data about the work environment, the locations of other workers, the types of PPE, the hazards detected by sensing stations, the configurations of PPE, and any other safety context data that may be usable by the safety assistant to generate the set of utterances that is semantically responsive to the expression of the worker.

Safety assistant 68J may generate one or more outputs based at least in part on the safety response data that represents a set of utterances that is semantically responsive to the expression of the worker about the safety event. In some examples, the output may be visual, audible, haptic, or otherwise sensory to a human. In some examples, the output may be a report, message sent to another computing device, or a file or other structured data that is stored, modified, or transferred. In the example of FIG. 2, the generated output based on the safety response data is an audio output indicating “John is properly protected but Mike requires a fit test” in response to the input from the worker 10 “Are all workers nearby protected by the right PPE?”. Using techniques of this disclosure, a worker may submit input to the safety assistant 68J comprising complex queries with multiple entities such as “are all the workers in my work environment protected by the correct types of PPE” and receive output that is semantically responsive to the expression of the worker.

FIG. 3 illustrates an example system including a mobile computing device, a set of personal protection equipment communicatively coupled to the mobile computing device, and a personal protection equipment management system communicatively coupled to the mobile computing device, in accordance with techniques of this disclosure. For purposes of illustration only, system 300 includes mobile computing device 302, which may be included within respirator head top 326.

Components of mobile computing device 302 may include processor 304, communication unit 306, storage device 308, worker-interface (UI) device 310, sensors 312. Mobile computing device 302 may also include components such as, but not limited to usage data 314, safety rules 316, rule engine 318, alert data 320, alert engine 322, and safety assistant 324. As noted above, mobile computing device 302 represents one example of hubs 14 shown in FIG. 1. Many other examples of mobile computing device 302 may be used in other instances and may include a subset of the components included in example mobile computing device 302 or may include additional components not shown example mobile computing device 302 in FIG. 3.

In some examples, mobile computing device 302 may be an intrinsically safe computing device, smartphone, wrist- or head-wearable computing device, or any other computing device that may include a set, subset, or superset of functionality or components as shown in mobile computing device 302. Communication channels may interconnect each of the components in mobile computing device 302 for inter-component communications (physically, communicatively, and/or operatively). In some examples, communication channels may include a hardware bus, a network connection, one or more inter-process communication data structures, or any other components for communicating data between hardware and/or software.

Mobile computing device 302 may also include a power source, such as a battery, to provide power to components shown in mobile computing device 302. A rechargeable battery, such as a Lithium Ion battery, can provide a compact and long-life source of power. Mobile computing device 302 may be adapted to have electrical contacts exposed or accessible from the exterior of the hub to allow recharging the mobile computing device 302. As noted above, mobile computing device 302 may be portable such that it can be carried or worn by a worker. Mobile computing device 302 can also be personal, such that it is used by an individual and communicates with personal protection equipment (PPE) assigned to that individual. Mobile computing device 302 may be secured to a worker by a strap. However, mobile computing device 302 may be carried by a worker or secured to a worker in other ways, such as being secured to PPE being worn by the worker, to other garments being worn to a worker, being attached to a belt, band, buckle, clip or other attachment mechanism as will be apparent to one of skill in the art upon reading the present disclosure. As described throughout this disclosure, in examples, functionality of mobile computing device 302 may be integrated into one or more articles of PPE, such that a separate mobile computing device 302 is not required to perform the techniques of this disclosure.

One or more processors 304 may implement functionality and/or execute instructions within mobile computing device 302. For example, processor 304 may receive and execute instructions stored by storage device 308. These instructions executed by processor 304 may cause mobile computing device 302 to store and/or modify information, within storage devices 308 during program execution. Processors 304 may execute instructions of components, such as safety assistant 324, rule engine 318, and alert engine 322 to perform one or more operations in accordance with techniques of this disclosure. That is, safety assistant 324, rule engine 318, and alert engine 322 may be operable by processor 304 to perform various functions described herein.

One or more communication units 306 of mobile computing device 302 may communicate with external devices by transmitting and/or receiving data. For example, mobile computing device 302 may use communication units 306 to transmit and/or receive radio signals on a radio network such as a cellular radio network. In some examples, communication units 306 may transmit and/or receive satellite signals on a satellite network such as a Global Positioning System (GPS) network. Examples of communication units 306 include a network interface card (e.g. such as an Ethernet card), an optical transceiver, a radio frequency transceiver, a GPS receiver, or any other type of device that can send and/or receive information. Other examples of communication units 306 may include Bluetooth®, GPS, 3G, 4G, and Wi-Fi® radios found in mobile devices as well as Universal Serial Bus (USB) controllers and the like.

One or more storage devices 308 within mobile computing device 302 may store information for processing during operation of mobile computing device 302. In some examples, storage device 308 is a temporary memory, meaning that a primary purpose of storage device 308 is not long-term storage. Storage device 308 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage device 308 may, in some examples, also include one or more computer-readable storage media. Storage device 308 may be configured to store larger amounts of information than volatile memory. Storage device 308 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage device 308 may store program instructions and/or data associated with components such as safety assistant 324, rule engine 318, and alert engine 322.

UI device 310 may be configured to receive worker input and/or output information to a worker. One or more input components of UI device 310 may receive input. Examples of input are tactile, audio, kinetic, and optical input, to name only a few examples. UI device 310 of mobile computing device 302, in one example, include a mouse, keyboard, voice responsive system, video camera, buttons, control pad, microphone or any other type of device for detecting input from a human or machine. In some examples, UI device 310 may be a presence-sensitive input component, which may include a presence-sensitive screen, touch-sensitive screen, etc.

One or more output components of UI device 310 may generate output. Examples of output are data, tactile, audio, and video output. Output components of UI device 310, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components may be integrated with mobile computing device 302 in some examples.

UI device 310 may include a display, lights, buttons, keys (such as arrow or other indicator keys), and may be able to provide alerts to the worker in a variety of ways, such as by sounding an alarm or vibrating. The worker interface can be used for a variety of functions. For example, a worker may be able to acknowledge or snooze an alert through the worker interface. The worker interface may also be used to control settings for the head top and/or other respirator peripherals that are not immediately within the reach of the worker. For example, a blower unit of the respirator may be worn on the lower back where the wearer cannot access the controls without significant difficulty.

Sensors 312 may include one or more sensors that generate data indicative of an activity of a worker 10 associated with mobile computing device 302 and/or data indicative of an environment in which mobile computing device 302 is located. Sensors 312 may include, as examples, one or more accelerometers, one or more sensors to detect conditions present in a particular environment (e.g., sensors for measuring temperature, humidity, particulate content, noise levels, air quality, or any variety of other characteristics of environments in which respirator 13 may be used), or a variety of other sensors.

Mobile computing device 302 may store usage data 314 from components of air respirator system 300. For example, as described herein, components of air respirator system 300 (or any other examples of respirators 13) may generate data regarding operation of system 300 that is indicative of activities of worker 10 and transmit the data in real-time or near real-time to mobile computing device 302.

In some examples, mobile computing device 302 may immediately relay usage data 314 to another computing device, such as PPEMS 6, via communication unit 306. In other examples, storage device 308 may store usage data 314 for some time prior to uploading the data to another device. For example, in some instances, communication unit 306 may be able to communicate with system 300 but may not have network connectivity, e.g., due to an environment in which system 300 is located and/or network outages. In such instances, mobile computing device 302 may store usage data 314 to storage device 308, which may allow the usage data to be uploaded to another device upon a network connection becoming available. Mobile computing device 302 may store safety rules 316 as described in this disclosure. Safety rules 316 may be stored in any suitable data store as described in this disclosure.

System 300 may include head top 326 and hearing protector 328, in accordance with this disclosure. As shown in FIG. 3, head top 326 may include structure and functionality that is similar to or the same as respirator 13A as described in FIG. 1 and other embodiments of this disclosures. Head top 326 (or other headworn device, such as a head band) may include hearing protector 328 that includes, ear muff attachment assembly 330. Ear muff attachment assembly 330 may include housing 332, an arm set 334, and ear muffs 336. Hearing protector 328 may include two separate ear muff cups 336, one of which is visible in FIG. 3 and the other on the opposite side of the worker's head and similarly configured to the visible ear muff cup in FIG. 3. Arm set 334 is rotatable between one or more different positions, such that hearing protector 328 may be adjusted and/or toggled, for example, between “active” and “standby” positions (or one or more additional intermediate positions). In an active position, hearing protector 328 is configured to at least partially cover a worker's ear. In a standby mode, hearing protector 328 is in a raised position away from and/or out of contact with a worker's head. A worker is able to switch between active and standby positions when entering or leaving an area necessitating hearing protection, for example, or as may be desired by the worker. Adjustment to a standby position allows hearing protector 328 to be readily available for the worker to move hearing protector 328 into an active position in which hearing protection is provided without the need to carry or store ear muffs.

Ear muff attachment assembly 330 may be attached directly or indirectly to a helmet, hard hat, strap, head band, or other head support, such as a head top 326. Head top 326 may be worn simultaneously with, and provide a support for, ear muff attachment assembly 330. Ear muff attachment assembly 330 is attached to an outer surface of head top 326, and arm set 334 extends generally downwardly around an edge of head top 326 such that ear muffs of hearing protector 328 may be desirably positioned to cover a worker's ear.

In various examples, head top 326 and ear muff attachment assembly 330 may be joined using various suitable attachment components, such as snap-fit components, rivets, mechanical fasteners, adhesive, or other suitable attachment components as known in the art. Ear muffs of hearing protector 328 are configured to cover at least a portion of a worker's ear and/or head. In FIG. 3, ear muffs exhibit a cup shape and include a cushion and a sound absorber (not shown). Cushions are configured to contact a worker's head and/or ear when ear muffs are in an active position forming an appropriate seal to prevent sound waves from entering. Arm set 334 extends outwardly from head top 326 and is configured to carry ear muffs of hearing protector 328.

In the example of FIG. 3, ear muff attachment assembly 330 may have positional or motion sensors to detect whether the ear muffs are in the standby or active position. The positional or motion sensor may generate one or more signals that indicate a particular position from a set of one or more positions. The signals may indicate one or more position values (e.g., discrete “active”/“standby” values, numeric position representations, or any other suitable encoding or measurement values). If, for example, the standby condition is detected by the one or more positional or motion sensors and if an environmental sound detector detects unsafe sound levels, then a computing device may generate an indication of output, such as a notification, log entry, or other type of output. In some examples, the indication of output may be audible, visual, haptic, or any other physical sensory output.

In high noise environment workers may be required to use hearing protection in the form of ear plugs or ear muffs. Ear muffs typically comprise cup shaped shell with a sound absorbing liner that seals against the ear of the worker. Many workers also use head and/or face protection while wearing ear muffs. Therefore, many ear muff models are designed to attach to a helmet, hard hat or other headgear, such as shown in FIG. 3. The ear muffs may be affixed to the headgear via an arm that attaches to the headgear and is adjustable between various positions over or away from the worker's ear.

As described above, headgear mounted ear muffs rotate between two positions: the active position where the ear muffs cover the worker's ears providing hearing protection, and the standby position where the ear muffs are rotated up and away from the ears. While in the standby position the ear muff does not provide hearing protection to the worker. In some types of headgear attached ear muffs, the muffs can be pivoted outward away from the ear of the worker in the standby position. In this case, the ear muffs rest at a small distance away from the head of the worker. In the active position, the muffs are pivoted toward the head where it is sealed around the ears of the worker providing hearing protection.

In some examples, one or more sensors 312 may be configured at head top 326 and/or hearing protector 328. For example, one or more microphones and/or speakers may be configured at head top 326 and/or hearing protector 328. In some examples, a microphone and/or speaker may be included within headtop 326 and proximate to the worker's face, ears or mouth. In some examples, a microphone and/or speaker may be included within hearing protector 328 and proximate to the worker's face, ears or mouth. In some examples, the one or more microphones may receive queries for a safety assistant from the worker. In some examples, the one or more speakers may output responses from a safety assistant in response to queries from the worker.

Rule engine 318 may be a combination of hardware and software that executes one or more safety rules, such as safety rules 316. For instance, rule engine 318 may determine which safety rules to execute based on context data, information included in the safety rule set, other information received from PPEMS 6 or other computing devices, worker input from the worker, or any other source of data that indicates which safety rules to execute. In some examples, safety rules 316 may be installed prior to a worker entering a work environment, while in other examples, safety rules 316 be dynamically retrieved by mobile computing device 302 based on context data generated at first particular point in time.

Rule engine 318 may execute safety rules periodically, continuously, or asynchronously. For instance, rule engine 318 may execute safety rules periodically by evaluating the conditions of such rules each time a particular time interval passes or expires (e.g., every second, every minute, etc.). In some examples, rule engine 318 may execute safety rules continuously by checking such conditions using one or more scheduling techniques that continuously evaluate the conditions of such rules. In some examples, rule engine 318 may execute safety rules asynchronously, such as in response to detecting an event. An event may be any detectable occurrence, such as moving to a new location, detecting a worker, coming within a threshold distance of another object, or any other detectable occurrence.

Rule engine 318, upon determining that a condition of a safety rule has or has not been satisfied may perform one or more actions associated with the safety rule by executing one or more operations that define the actions. For instance, rule engine 318 may execute a condition that determines if a worker is approaching or has entered a work environment, (a) whether a PAPR is being worn by the worker and (b) whether the filter in the PAPR of a particular type of filter, e.g., a filter that removes contaminants of a particular type. This safety rule may specify actions if the condition is not satisfied which cause rule engine 318 to generate an alert at mobile computing device 302 using UI device 310 and send a message using communication unit 306 to PPEMS 6, which may cause PPEMS 6 to send a notification to a remote worker (e.g., the safety manager).

Alert data 320 may be used for generating alerts for output by UI device 310. For example, mobile computing device 302 may receive alert data from PPEMS 6, end-worker computing devices 16, remote workers using computing devices 18, safety stations 15, or other computing devices as illustrated in FIG. 1. In some examples, alert data 320 may be based on operation of system 300. For example, mobile computing device 302 may receive alert data 320 that indicates a status of system 300, that system 300 is appropriate for the environment in which system 300 is located, that the environment in which system 300 is located is unsafe, or the like.

In some examples, additionally or alternatively, mobile computing device 302 may receive alert data 320 associated with a likelihood of a safety event. For example, as noted above, PPEMS 6 may, in some examples, apply historical data and models to usage data from system 300 in order to compute assertions, such as anomalies or predicted occurrences of imminent safety events based on environmental conditions or behavior patterns of a worker using system 300. That is, PPEMS 6 may apply analytics to identify relationships or correlations between sensed data from system 300, environmental conditions of environment in which system 300 is located, a geographic region in which system 300 is located, and/or other factors. PPEMS 6 may determine, based on the data acquired across populations of workers 10, which particular activities, possibly within certain environment or geographic region, lead to, or are predicted to lead to, unusually high occurrences of safety events. Mobile computing device 302 may receive alert data 320 from PPEMS 6 that indicates a relatively high likelihood of a safety event.

Alert engine 322 may be a combination of hardware and software that interprets alert data 320 and generate an output at UI device 310 (e.g., an audible, visual, or tactile output) to notify worker 10 of the alert condition (e.g., that the likelihood of a safety event is relatively high, that the environment is dangerous, that system 300 is malfunctioning, that one or more components of system 300 need to be repaired or replaced, or the like). In some instances, alert engine 322 may also interpret alert data 320 and issue one or more commands to system 300 to modify operation or enforce rules of system 300 in order to bring operation of system 300 into compliance with desired/less risky behavior. For example, alert engine 322 may issue commands that control the operation of head top 326 or a clean air supply source.

In the example of FIG. 3, safety assistant 324 may receive input from workers and determine safety response data that is semantically responsive to the expression of the worker. Safety assistant 324 may be an example of safety assistant 500 in FIG. 5. For example, safety assistant 324 may receive audio data via sensors 312 that represents a set of utterances from a worker. The audio data may be generated by a microphone or other sensor positioned or integrated at any one or more components of system 300. The set of utterances may represent at least one expression of the worker. In some examples, an utterance may be any spoken word, statement, or vocal sound. For instance, the set of utterances may represent the sentence “Are all workers nearby protected by the right PPE?”.

Safety assistant 324 may select a set of safety context data that characterizes at least one of the worker, a worker environment, or an article of personal protection equipment. In some examples, the safety context data may be from one or more sensors configured at PPE, workers, sensing stations, safety stations, beacons or any other sensors in one or more environments. In some examples, the safety context data may be from PPEMS 6 or any other computing devices. In some examples, the safety context data may be from any data stored at computing device 302 and/or components configured at computing device 302.

In accordance with techniques of this disclosure, safety assistant 324 may determine, based at least in part on the safety context data and applying natural language processing to the utterances of the worker, safety response data. In some examples, safety response data represents a set of utterances that is semantically responsive to the expression of the worker. For example, the set of utterances may be machine-generated by or at computing device 302 as further described in FIG. 5. In the example of FIG. 3, the set of utterances generated by or at computing device 302 may include the statement “John is properly protected but Mike requires a fit test”. The response data may be generated based on the safety assistant performing natural language processing on the set of utterances of the worker with safety context data about the work environment, the locations of other workers, the types of PPE, the hazards detected by sensing stations, the configurations of PPE, and any other safety context data that may be usable by the safety assistant to generate the set of utterances that is semantically responsive to the expression of the worker.

Safety assistant 324 may generate one or more outputs based at least in part on the safety response data that represents a set of utterances that is semantically responsive to the expression of the worker about the safety event. In some examples, the output may be visual, audible, haptic, or otherwise sensory to a human. In some examples, the output may be a report, message sent to another computing device, or a file or other structured data that is stored, modified, or transferred. In the example of FIG. 3, the generated output based on the safety response data is an audio output indicating “John is properly protected but Mike requires a fit test” in response to the input from the worker “Are all workers nearby protected by the right PPE?”. Using techniques of this disclosure, a worker may submit input to the safety assistant 324 comprising complex queries with multiple entities such as “are all the workers in my work environment protected by the correct types of PPE” and receive output that is semantically responsive to the expression of the worker. In some examples, safety assistant 324 may communicate with PPEMS 6 (which may also include one or more components of safety assistant 324) to generate safety response data that is semantically responsive to the expression of the worker.

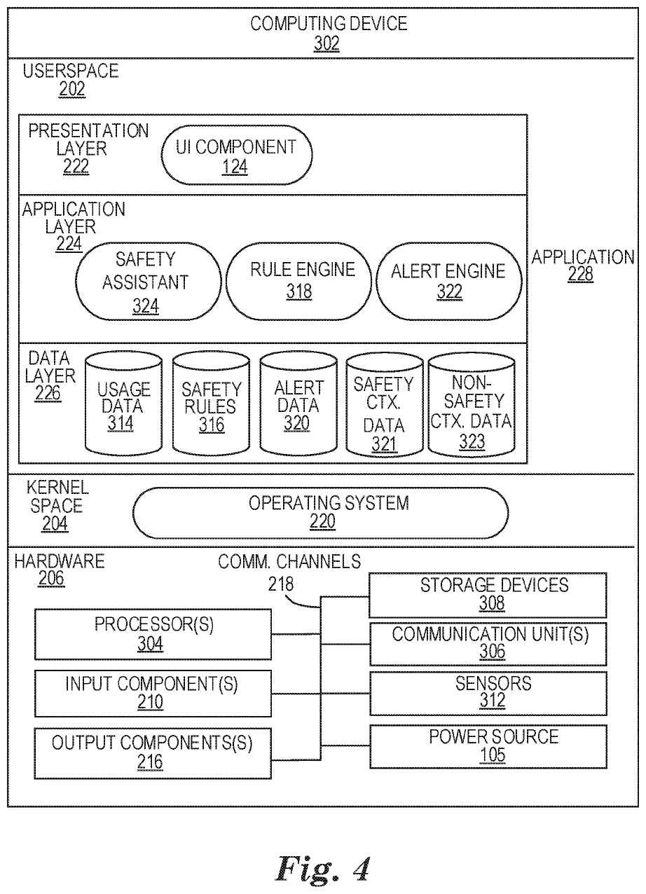

FIG. 4 is a block diagram illustrating an example computing device, in accordance with one or more aspects of the present disclosure. FIG. 4 illustrates only one example of computing device 302, as also shown in FIG. 3. Many other examples of computing device 302 may be used in other instances and may include a subset of the components included in example computing device 302 or may include additional components not shown example computing device 302 in FIG. 4.

In some examples, computing device 302 may be an in-PPE computing device or in-PPE sub-system, server, tablet computing device, smartphone, wrist- or head-worn computing device, laptop, desktop computing device, or any other computing device that may run a set, subset, or superset of functionality included in application 228. In some examples, computing device 302 may correspond to a computing device configured at PPE in FIG. 1 or computing device 302 in FIG. 3.

As shown in the example of FIG. 4, computing device 302 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202. In some examples, any components, functions, operations, and/or data may be included or executed in kernel space 204 and/or implemented as hardware components in hardware 206. Although application 228 is illustrated as an application executing in userspace 202, different portions of application 228 and its associated functionality may be implemented in hardware and/or software (userspace and/or kernel space).

As shown in FIG. 4, hardware 206 includes one or more processors 304, input components 210, storage devices 308, communication units 306, output components 216, sensors 312, and power source 105. Processors 304, input components 210, storage devices 308, communication units 306, output components 216, and power source 105 may each be interconnected by one or more communication channels 218. Communication channels 218 may interconnect each of the components 105, 312, 304, 210, 308, 306, and 216 for inter-component communications (physically, communicatively, and/or operatively). In some examples, communication channels 218 may include a hardware bus, a network connection, one or more inter-process communication data structures, or any other components for communicating data between hardware and/or software.

One or more processors 304 may implement functionality and/or execute instructions within computing device 302. For example, processors 304 on computing device 302 may receive and execute instructions stored by storage devices 308 that provide the functionality of components included in kernel space 204 and user space 202. These instructions executed by processors 304 may cause computing device 302 to store and/or modify information, within storage devices 308 during program execution. Processors 304 may execute instructions of components in kernel space 204 and user space 202 to perform one or more operations in accordance with techniques of this disclosure. That is, components included in user space 202 and kernel space 204 may be operable by processors 304 to perform various functions described herein.

One or more input components 210 of computing device 302 may receive input. Examples of input are tactile, audio, kinetic, and optical input, to name only a few examples. Input components 210 of computing device 302, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 306 of computing device 302 may communicate with external devices by transmitting and/or receiving data. For example, computing device 302 may use communication units 306 to transmit and/or receive radio signals on a radio network such as a cellular radio network. In some examples, communication units 306 may transmit and/or receive satellite signals on a satellite network such as a Global Positioning System (GPS) network. Examples of communication units 306 include a network interface card (e.g. such as an Ethernet card), an optical transceiver, a radio frequency transceiver, a GPS receiver, or any other type of device that can send and/or receive information. Other examples of communication units 306 may include Bluetooth®, GPS, 3G, 4G, and Wi-Fi® radios found in mobile devices as well as Universal Serial Bus (USB) controllers and the like.

One or more output components 216 of computing device 302 may generate output. Examples of output are tactile, audio, and video output. Output components 216 of computing device 302, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 302 in some examples.

In other examples, output components 216 may be physically external to and separate from computing device 302, but may be operably coupled to computing device 302 via wired or wireless communication. An output component may be a built-in component of computing device 302 located within and physically connected to the external packaging of computing device 302 (e.g., a screen on a mobile phone). In another example, a presence-sensitive display may be an external component of computing device 302 located outside and physically separated from the packaging of computing device 302 (e.g., a monitor, a projector, etc. that shares a wired and/or wireless data path with a tablet computer).

One or more storage devices 308 within computing device 302 may store information for processing during operation of computing device 302. In some examples, storage device 308 is a temporary memory, meaning that a primary purpose of storage device 308 is not long-term storage. Storage devices 308 on computing device 302 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 308, in some examples, also include one or more computer-readable storage media. Storage devices 308 may be configured to store larger amounts of information than volatile memory. Storage devices 308 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 308 may store program instructions and/or data associated with components included in user space 202 and/or kernel space 204.

Computing device 302 may also include power source 105, such as a battery, to provide power to components shown in computing device 302. A rechargeable battery, such as a Lithium Ion battery, may provide a compact and long-life source of power. Computing device 302 may be adapted to have electrical contacts exposed or accessible from the exterior of the housing of computing device 302 to allow recharging of power source 105. Other examples of power source 105 may be a primary battery, replaceable battery, rechargeable battery, inductive coupling, or the like. A rechargeable battery may be recharged via a wired or wireless means.

As shown in FIG. 4, application 228 executes in userspace 202 of computing device 302. Application 228 may be logically divided into presentation layer 222, application layer 224, and data layer 226. Presentation layer 222 may include worker interface (UI) component 124, which generates and renders worker interfaces of application 228. Application 228 may include, but is not limited to: UI component 124, safety assistant 324, rule engine 318, alert engine 322. For instance, application layer 224 may include safety assistant 324, rule engine 318, alert engine 322. Presentation layer 222 may include UI component 124.

Data layer 226 may include one or more datastores. A datastore may store data in structure or unstructured form. Example datastores may be any one or more of a relational database management system, online analytical processing database, table, or any other suitable structure for storing data. Data layer 226 may include usage data 314, safety rules 316, alert data 320, safety context data 321, and non-safety context data 323.

In the example of FIG. 4, safety assistant 324 may receive input from workers and determine safety response data that is semantically responsive to the expression of the worker. Safety assistant 324 may be an example of safety assistant 500 in FIG. 5. For example, safety assistant 324 may receive audio data via sensors 312 that represents a set of utterances from a worker. The audio data may be generated by a microphone or other sensor positioned or integrated at any one or more components of system 300. The set of utterances may represent at least one expression of the worker. In some examples, an utterance may be any spoken word, statement, or vocal sound. For instance, the set of utterances may represent the sentence “Are all workers nearby protected by the right PPE?”.

Safety assistant 324 may select a set of safety context data that characterizes at least one of the worker, a worker environment, or an article of personal protection equipment. In some examples, the safety context data may be from one or more sensors configured at PPE, workers, sensing stations, safety stations, beacons or any other sensors in one or more environments. In some examples, the safety context data may be from PPEMS 6 or any other computing devices. In some examples, the safety context data may be from any data stored at computing device 302 and/or components configured at computing device 302.

In accordance with techniques of this disclosure, safety assistant 324 may determine, based at least in part on the safety context data and applying natural language processing to the utterances of the worker, safety response data. In some examples, safety response data represents a set of utterances that is semantically responsive to the expression of the worker. For example, the set of utterances may be machine-generated by at computing device 302 as further described in FIG. 5. In the example of FIG. 3, the set of utterances generated by at computing device 302 may include the statement “John is properly protected but Mike requires a fit test”. The response data may be generated based on the safety assistant performing natural language processing on the set of utterances of the worker with safety context data about the work environment, the locations of other workers, the types of PPE, the hazards detected by sensing stations, the configurations of PPE, and any other safety context data that may be usable by the safety assistant to generate the set of utterances that is semantically responsive to the expression of the worker.

Safety assistant 324 may generate one or more outputs based at least in part on the safety response data that represents a set of utterances that is semantically responsive to the expression of the worker about the safety event. In some examples, the output may be visual, audible, haptic, or otherwise sensory to a human. In some examples, the output may be a report, message sent to another computing device, or a file or other structured data that is stored, modified, or transferred. In the example of FIG. 3, the generated output based on the safety response data is an audio output indicating “John is properly protected but Mike requires a fit test” in response to the input from the worker “Are all workers nearby protected by the right PPE?”. Using techniques of this disclosure, a worker may submit input to the safety assistant 324 comprising complex queries with multiple entities such as “are all the workers in my work environment protected by the correct types of PPE” and receive output that is semantically responsive to the expression of the worker. In some examples, safety assistant 324 may communicate with PPEMS 6 (which may also include one or more components of safety assistant 324) to determine safety response data that is semantically responsive to the expression of the worker.

FIG. 5 is a block diagram illustrating a safety assistant in accordance with various techniques of this disclosure. FIG. 5 provides an operating perspective of safety assistant 500, which may be implemented as a combination of hardware and/or software in one or more computing devices. For example purposes, safety assistant 500 may be an example of safety assistant 324 of FIG. 3 or safety assistant 68J of FIG. 2. In other examples, safety assistant 500 may be implemented in other devices such as physical integrated or attached to an article of personal protection equipment. Although safety assistant 500 is illustrated with various components in FIG. 5, many other examples of safety assistant 500 may be used in other instances and may include a subset of the components included in example safety assistant 500 or may include additional components not shown in safety assistant 500.

Safety assistant 500 may include I/O interface 502. I/O interface 502 may be a combination of hardware and/or software through which worker inputs and safety assistant outputs (e.g., safety response data) are communicated with other components of a computing device. In some examples I/O interface 502 interacts with the worker through various input and/or output devices described in this disclosure or through communication units described in this disclosure to obtain worker input (e.g., utterances) and to provide responses (e.g., safety response data) to the input. I/O interface 502 may receive safety context data from other components, such as sensors configured at personal protection equipment, workers, and/or work environments. Non-safety context data, (e.g., other than safety context data), may include worker-specific data, vocabulary, and/or preferences relevant to the worker input. In some examples, non-safety context data also includes software and hardware states of the worker device at the time the worker input is received, and/or information related to the surrounding environment of the worker at the time that the worker request was received. In some examples, I/O interface 502 may sends follow-up questions to, and receive answers from, the worker regarding the worker request. When a worker request is received by I/O interface 502 and the worker request includes speech input, I/O interface 502 may forward the speech input to speech-to-text (STT) component 504 for speech-to-text conversions.

STT component 504 may include one or more Automatic Speech Recognition (ASR) systems. The one or more ASR systems may process the speech input that is received through I/O interface 502 to produce a recognition result. An ASR system may include a front-end speech pre-processor. The front-end speech pre-processor may extract representative features from the speech input. For example, the front-end speech pre-processor may perform a Fourier transform on the speech input to extract spectral features that characterize the speech input as a sequence of representative multi-dimensional vectors. Further, each ASR system may include one or more speech recognition models (e.g., acoustic models and/or language models) and may implement one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines may be used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input may be processed at least partially by a third-party service or on the worker's device (e.g., computing device 302 or PPEMS 6) to produce the recognition result. Once STT component 504 produces recognition results containing a text string (e.g., words, or sequence of words, or sequence of tokens), the recognition result may be passed to natural language processing component 512 for intent deduction. In some examples, STT component 504 produces multiple candidate text representations of the speech input. Each candidate text representation may be a sequence of words or tokens corresponding to the speech input. In some examples, each candidate text representation is associated with a speech recognition confidence score. Based on the speech recognition confidence scores, STT component 504 may rank the candidate text representations and may provide the n-best (e.g., n highest ranked) candidate text representation(s) to natural language processing component 512 for intent deduction, where n is a predetermined integer greater than zero. For example, in one example, only the highest ranked (n=1) candidate text representation is passed to natural language processing component 512 for intent deduction. In another example, the five highest ranked (n=5) candidate text representations may be passed to natural language processing component 512 for intent deduction. More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT component 504 may include and/or access a vocabulary of recognizable words via phonetic conversion component 506. Each vocabulary word may be associated with one or more candidate pronunciations of the word represented in a speech recognition phonetic alphabet. In particular, the vocabulary of recognizable words may include a word that is associated with a plurality of candidate pronunciations. For example, the vocabulary may include the word “tomato” that may be associated with one or more candidate pronunciations. Further, vocabulary words may be associated with custom candidate pronunciations that are based on previous speech inputs from the worker. Such custom candidate pronunciations may be stored in STT component 504 and are associated with a particular worker via the worker's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations may be ranked based on the commonness of the candidate pronunciation. For example, a first candidate pronunciation may be ranked higher than a second candidate pronunciation, because the former is a more commonly used pronunciation (e.g., among all workers, for workers in a particular geographical region, or for any other appropriate subset of workers). In some examples, candidate pronunciations are ranked based on whether the candidate pronunciation is a custom candidate pronunciation associated with the worker. For example, custom candidate pronunciations may be ranked higher than canonical candidate pronunciations. This can be useful for recognizing proper nouns having a unique pronunciation that deviates from canonical pronunciation. In some examples, candidate pronunciations may be associated with one or more speech characteristics, such as geographic origin, nationality, or ethnicity. For example, a first candidate pronunciation may be associated with the United States, whereas a second candidate pronunciation may be associated with Great Britain. Further, the rank of the candidate pronunciation may be based on one or more characteristics (e.g., geographic origin, nationality, ethnicity, etc.) of the worker stored in the worker's profile on the device. For example, it can be determined from the worker's profile that the worker is associated with the United States. Based on the worker being associated with the United States, the first candidate pronunciation (associated with the United States) is ranked higher than the second candidate pronunciation (associated with Great Britain). In some examples, one of the ranked candidate pronunciations is selected as a predicted pronunciation (e.g., the most likely pronunciation).

When a speech input is received, STT component 504 may be used to determine the phonemes corresponding to the speech input (e.g., using an acoustic model), and then attempt to determine words that match the phonemes (e.g., using a language model). For example, if STT component 504 first identifies a sequence of phonemes corresponding to a portion of the speech input, it can then determine, based on vocabulary 508, that this sequence corresponds to a particular word. In some examples, STT component 504 may use approximate matching techniques to determine words in an utterance. Thus, for example, STT component 504 may determine that a sequence of phonemes corresponds to a particular word, even if that particular sequence of phonemes is not one of the candidate sequence of phonemes for that particular word.

Natural language processing component 512 (or a “natural language processor”) may select the n-best candidate text representation(s) (“word sequence(s)” or “token sequence(s)”) generated by STT component 504 and attempts to associate each of the candidate text representations with one or more “actionable intents” recognized by the digital assistant. An “actionable intent” (or “worker intent”) represents a set of operations that can be performed by the digital assistant, and implemented in safety response data 520. The associated operations may be a series of programmed actions and steps that the digital assistant takes response to the worker input. The scope of a digital assistant's capabilities may be dependent on the number and variety of operations that have been implemented and stored in operations, or in other words, on the number and variety of “actionable intents” that the digital assistant recognizes. The effectiveness of the digital assistant, however, may also depend on the assistant's ability to infer the correct “actionable intent(s)” from the worker request expressed in natural language.

In some examples, in addition to the sequence of words or tokens obtained from STT component 504, natural language processing component 512 also receives safety context data and/or non-safety context data associated with the worker input, e.g., from I/O interface 502. The Natural language processing component 512 may use the safety context data and/or non-safety context data to clarify, supplement, and/or further define the information contained in the candidate text representations received from STT component 504 and/or to determine safety response data by one or more components of safety assistant 500. The non-safety context data may include, for example, worker preferences, hardware, and/or software states of the worker device, information collected before, during, or shortly after the worker input, prior interactions (e.g., dialogue) between the digital assistant and the worker, and the like. As described herein, non-safety and/or safety context data may be, in some examples, dynamic, and change with time, location, content of the dialogue, and other factors.

An actionable intent node, along with its linked concept nodes, is described as a “domain.” In the present discussion, each domain is associated with a respective actionable intent, and refers to the group of nodes (and the relationships there between) associated with the particular actionable intent. For example, an ontology may include an example of personal protection equipment domain, a worker domain, and a work environment domain, to name only a few examples. The personal protection equipment domain may include but is not limited to: actionable intent node “check PPE readiness state”, “check PPE component compatibility”, “check PPE fit test”; PPE device nodes “PPE type”, “PPE model”, “PPE issue date”, “PPE owner”, “PPE use time”. The worker domain may include but is not limited to: actionable intent nodes “check for hazards”, “list hazard type(s)”, “check if workers present”, “list PPE requirements”; environment nodes may include “location”, “climate”, “owner”, “environment type”, “hazard type”. The worker may include but is not limited to: actionable intent nodes “check worker distress”, “check work time today”, “is worker wearing correct PPE”, “is worker trained”; worker nodes may include “worker name”, “worker role”, “worker experience”, “worker physiological metric”, “worker location”. Although the following nodes are representative of PPE, work environment, and worker, any suitable properties may be used for such nodes.

In some examples, the ontology includes all the domains (and hence actionable intents) that the digital assistant is capable of understanding and acting upon. In some examples, the ontology is modified, such as by adding or removing entire domains or nodes, or by modifying relationships between the nodes within the ontology. In some examples, nodes associated with multiple related actionable intents are clustered under a “super domain” in the ontology. For example, a “worker check” super-domain includes a cluster of property nodes and actionable intent nodes related to checking whether the worker is safe and/or in a state to safely work. The actionable intent nodes related to worker check may include but are not limited to “check PPE readiness state,” “check PPE fit test,” “is worker wearing correct PPE,” and so on. The actionable intent nodes under the same super domain (e.g., the “worker check” super domain) have many property nodes in common. For example, the actionable intent nodes for “check PPE readiness state” and “check PPE fit test,” may share one or more of the property nodes “PPE use time” and “PPE type.”

In some examples, each node in the ontology may be associated with a set of words and/or phrases that are relevant to the property or actionable intent represented by the node. The respective set of words and/or phrases associated with each node are the so-called “vocabulary” associated with the node. The respective set of words and/or phrases associated with each node may be stored in vocabulary 508 in association with the property or actionable intent represented by the node. For example, a vocabulary associated with the node for the property of “work environment” includes words such as “organic vapor,” “lead dust,” “confined space,” “high-temperature,” “wet surfaces,” “nuclear,” “pharmaceutical,” and so on. For another example, the vocabulary associated with the node for the actionable intent of “is worker trained” includes words and phrases such as “worker,” “certified,” “qualified,” “person,” and so on. Vocabulary 508 may include words and phrases in different languages.

Natural language processing component 512 may receive the candidate text representations (e.g., text string(s) or token sequence(s)) from STT component 504, and for each candidate representation, determines what nodes are implicated by the words in the candidate text representation. In some examples, if a word or phrase in the candidate text representation is found to be associated with one or more nodes in the ontology (via vocabulary 508), the word or phrase “triggers” or “activates” those nodes. Based on the quantity and/or relative importance of the activated nodes, natural language processing component 512 selects one of the actionable intents as the operations that the worker intended the digital assistant to perform in response to the worker's input. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a worker.

Worker data 510 may include worker-specific information, such as worker -specific vocabulary, worker preferences, worker profile, worker's default and secondary languages, worker's contact list, and other short-term or long-term information for each worker. In some examples, natural language processing component 512 may use the worker-specific information to supplement the information contained in the worker input to further define the worker intent. For example, for a worker request “check if I'm wearing the correct PPE,” natural language processing component 512 is able to access worker data 510 to determine the PPE worn by the worker, rather than requiring the worker to provide such PPE information explicitly in his/her request.

It should be recognized that in some examples, natural language processing component 512 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing component 512 can select one or more candidate actionable intents from the set of candidate actionable intents based on the determined intent confidence scores. In some examples, an ontology is also used to select the one or more candidate actionable intents from the set of candidate actionable intents. Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing component 512 identifies an actionable intent (or domain) based on the worker request, natural language processing component 512 may generate a structured query to represent the identified actionable intent. In some examples, the structured query includes parameters for one or more nodes within the domain for the actionable intent, and at least some of the parameters are populated with the specific information and requirements specified in the worker request. For example, the worker says “Tell me the work hazards nearby.” In this case, natural language processing component 512 is able to correctly identify the actionable intent to be “list hazard type(s)” based on the worker input. According to the ontology, a structured query for a “list hazard type(s)” domain includes parameters such as (Location), (Time), (Date), and the like. In some examples, based on the speech input and the text derived from the speech input using STT component 504, natural language processing component 512 generates a partial structured query for the work environment domain, where the partial structured query includes the parameter (Location=“44.599342, −95.258189”). However, in this example, the worker's utterance contains insufficient information to complete the structured query associated with the domain. Therefore, other necessary parameters such as {Date} and {Time} is not specified in the structured query based on the information currently available. In some examples, natural language processing component 512 populates some parameters of the structured query with received safety- and/or non-safety contextual information. For example, in some examples, if the worker specified “now” natural language processing component populates {Date} and {Time} parameters in the structured query with the current date and time.

In some examples, natural language processing component 512 identifies multiple candidate actionable intents for each candidate text representation received from STT component 504. Further, in some examples, a respective structured query (partial or complete) is generated for each identified candidate actionable intent. Natural language processing component 512 may determine an intent confidence score for each candidate actionable intent and ranks the candidate actionable intents based on the intent confidence scores. In some examples, natural language processing component 512 passes the generated structured query (or queries), including any completed parameters, to safety response component 518. In some examples, the structured query (or queries) for the m-best (e.g., m highest ranked) candidate actionable intents are provided to safety response component 518, where m is a predetermined integer greater than zero. In some examples, the structured query (or queries) for the m-best candidate actionable intents are provided to safety response component 518 with the corresponding candidate text representation(s). Other details of inferring a worker intent based on multiple candidate actionable intents determined from multiple candidate text representations of a speech input are described in U.S. Utility application Ser. No. 14/298,725 for “System and Method for Inferring Worker Intent From Speech Inputs,” filed Jun. 6, 2014, the entire disclosure of which is incorporated herein by reference.

Safety response component 518 may be configured to receive the structured query (or queries) from natural language processing component 512, complete the structured query, if necessary, and perform the actions required to “complete” the worker's ultimate request. In some examples, the various procedures necessary to determine safety response data are provided safety response data 520. In some examples, safety response data 520 include procedures for obtaining additional information from the worker and safety response data for performing actions associated with the actionable intent.

As described above, in order to complete a structured query, safety response component 518 may need to initiate additional dialogue with the worker in order to obtain additional information, and/or disambiguate potentially ambiguous utterances. When such interactions are necessary, safety response component 518 invokes dialogue processing component 522 to engage in a dialogue with the worker. In some examples, dialogue processing component 522 determines how (and/or when) to ask the worker for the additional information and receives and processes the worker responses. The questions are provided to and answers are received from the workers through I/O interface 502. In some examples, dialogue processing component 522 presents dialogue output to the worker via audio and/or visual output, and receives input from the worker via spoken or physical (e.g., clicking) responses. Continuing with the example above, when safety response component 518 invokes dialogue processing component 522 to determine “temperature” and “degrees” information for the structured query associated with the domain “change environment condition,” dialogue processing component 522 generates questions to pass to the worker (e.g., worker: “I want to change the environment conditions” assistant: “which condition” worker: “temperature” assistant: “what temperature would you like” worker: “65 degrees Fahrenheit”). Once answers are received from the worker, dialogue processing component 522 then populates the structured query with the missing information, or pass the information to safety response component 518 to complete the missing information from the structured query.

Once safety response component 518 has completed the structured query for an actionable intent, safety response component 518 proceeds to determine or generate safety data associated with the actionable intent. Accordingly, safety response component 518 executes the steps and instructions in one or more models (stored, for example, in safety response data 520) for determining or generating safety response data according to the specific parameters contained in the structured query. For example, the model for the actionable intent of “change environment condition” includes steps and instructions for adjusting temperature, humidity, air flow, or other conditions of a work environment. For example, using a structured query such as: {change environment condition, site_identifier=Site 76, temperature=65 degrees F.}, safety response component 518 performs the steps of: (1) identifying the site location, (2) sending a command to the thermostat for the climate control system specifying 65 degrees, (3) sending an audible confirmation to the worker who submitted the request.

In some examples, safety response component 518 employs the assistance of safety service component 514 to determine or generate safety response data that is responsive to the worker input or to provide an informational answer requested in the worker input. In some examples, the protocols and application programming interfaces (API) required by each service are specified by a respective service model among service data 516. Safety service component 514 accesses the appropriate service model for a service and generate requests for the service in accordance with the protocols and APIs required by the service according to the service model.

Safety response component 518, when determining or generating safety response data, may cause safety service component 514 to perform one or more services. Safety service component 514 may interoperate, communicate, control or otherwise cause one or more other components of PPEM 6, computing device 302, PPE 13, safety stations 15, data hubs 14, or any other computing devices of FIG. 1 to perform one or more operations.

In some examples, to determine safety response data that represents a set of utterances that is semantically responsive to the expression of the worker about the safety event, STT component 504 and/or phonetic conversion component 506 may determine a set of phonetic features that correspond to the first set of utterances that represents at least one expression of the worker about the safety event. Natural language processing component 512 and/or STT component 504 may determine, based at least in part on the phonetic features, a set of words included in a spoken language that represent the expression of the worker about the safety event. Safety response component 518 may determine, based at least in part on the safety context data and one or more semantic relationships between the set of words that represent the expression of the worker about the safety event, the safety response data that is semantically responsive to the expression of the worker about the safety event.

In some examples, to determine, based at least in part on the safety context data and the one or more semantic relationships between the set of words that represent the expression of the worker about the safety event, the safety response data, natural language processing component 512 and/or safety response component 518 may determine, based at least in part on the set of words, at least one of an operation or a another set of words that correspond to the safety context data and determine the safety response data based at least in part on at least one of the operation or the second set of words that correspond to the safety context data. In some examples, to determine the safety response data, natural language processing component 512 and/or safety response component 518 may determine a set of phonetic features that correspond to the set of words, and speech synthesis component 524 may encode, based at least in part on the second set of phonetic features, audio data in the safety response data that represents second plurality of utterances.

In some examples, to generate an output based at least in part on the safety response data, safety response component 518 may identify personal protection equipment based at least in part on an association between the worker and the personal protection equipment. Safety response component 518 may determine, based at least in part on the safety context data, whether one or more states of the identified personal protection equipment of the worker satisfy the one or more pre-defined conditions. Safety response component 518 may determine the safety response data based at least in part on whether the identified personal protection equipment of the worker satisfies the one or more pre-defined conditions. In some examples, the safety event comprises one or more states of the personal protection equipment of the worker not satisfying the one or more pre-defined conditions for use by the worker.

In some examples, to generate an output based at least in part on the safety response data, safety response component 518 may identify the work environment based at least in part on an association between the worker and the work environment. Safety response component 518 may determine, based at least in part on the safety context data, whether one or more states of the work environment of the worker satisfy the one or more pre-defined conditions. Safety response component 518 may determine the safety response data based at least in part on whether one or more states of the work environment of the worker satisfy the one or more pre-defined conditions. In some examples, the safety event comprises the one or more states of the work environment not satisfying the one or more pre-defined conditions.

In some examples, to generate an output based at least in part on the safety response data, safety response component 518 may identify the worker and determine, based at least in part on the safety context data, whether one or more states of the worker satisfy the one or more pre-defined conditions. Safety response component 518 may determine the safety response data based at least in part on whether the one or more states of the worker satisfy the one or more pre-defined conditions. In some examples, the safety event comprises the one or more states of the of the worker not satisfying the one or more pre-defined conditions.

In some examples, a set of safety context data comprises at least one of historical safety context data or in situ safety context data received from one or more sensors configured at one or more of the worker, a work environment of the worker, or personal protection equipment of the worker. In situ may refer to data generated in a work environment or while a worker is operating in a work environment. In some examples, to determine safety response data that represents a set of utterances in response to user input, one or more of STT component 504, phonetic conversion component 506 and natural language processing component 512 may determine a sentiment state of the at least one expression of the worker from natural language processing of set of utterances. Safety response component 518 may determine, based at least in part on the sentiment state, the safety response data.

In some examples, safety context data that characterizes the one or more workers may include at least one of worker identity, worker experience, worker training, worker location, worker physiological metric, or worker role. In some examples, safety context data that characterizes the work environment may include at least one of work environment identity, work environment location, work environment climate, work environment owner, work environment hazard, work environment type, or work environment condition. In some examples, safety context data that characterizes the personal protection equipment may include at least one of PPE type, PPE model, PPE issue date, PPE owner, or PPE use time. In some examples, output generated by safety assistant 500 may indicate one or more remedial actions that are semantically responsive to the expression of the worker about the safety event.

In some examples, utterances from the worker may indicate a PPE fit test (e.g., “is my PPE fitting properly”). Safety response component 518 may initiate a fit test, such as by sending one or more messages to the PPE of the worker who provided the input. Output from safety response component 518 (which may be based on data from the PPE) may be based at least in part on whether the PPE fit test, initiated in response to the first plurality of utterances, passed or failed.

In some examples, wherein utterances from the worker may correspond to at least two of a worker, work environment, or personal protection equipment (e.g., “do I have the correct PPE for this work environment?”). To determine the safety response data, safety response component 518 may determine the safety response data based at least in part on the at least two of the worker, the work environment, or the personal protection equipment. For example, safety response component 518 may cause safety service component 514 to determine the worker identity, work environment identity, and identity of the PPE worn by the worker. Safety service component 514 may determine one or more conditions, rules, or regulations. The conditions, rules, or regulations may indicate the necessary PPE for the hazards of the work environment. Safety service component 514 may determine (based on the current worker identity, work environment identity, and identity of the PPE worn by the worker) properties or characteristics of the worker, work environment and identity to determine whether the conditions, rules, or regulations are satisfied. Safety service component 514 may indicate to safety response component 518 whether the conditions, rules, or regulations are satisfied and safety response component 518 may cause one or more outputs to be generated in accordance with techniques of this disclosure.

In some examples, all of the utterances from a worker's input do not represent a pre-defined command mapped directly to a response value. For example, a worker's set of utterances may not exclusively and not only be pre-defined commands.

In some examples, natural language processing component 512, dialogue processing component 522, and safety response component 518 are used collectively and iteratively to infer and define the worker's intent, obtain information to further clarify and refine the worker intent, and finally generate a response (i.e., an output to the worker, or the completion of a task) to fulfill the worker's intent. The generated response is a dialogue response to the speech input that at least partially fulfills the worker's intent. Further, in some examples, the generated response is output as a speech output. In these examples, the generated response is sent to speech synthesis component 524 (e.g., speech synthesizer) where it can be processed to synthesize the dialogue response in speech form. In yet other examples, the generated response is data content relevant to satisfying a worker request in the speech input.

In examples where safety response component 518 receives multiple structured queries from natural language processing component 512, safety response component 518 may initially process the first structured query of the received structured queries to attempt to complete the first structured query and/or determine or generate safety response data. In some examples, the first structured query corresponds to the highest ranked actionable intent. In other examples, the first structured query is selected from the received structured queries based on a combination of the corresponding speech recognition confidence scores and the corresponding intent confidence scores. In some examples, if safety response component 518 encounters an error during processing of the first structured query (e.g., due to an inability to determine a necessary parameter), the safety response component 518 may proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis component 524 may be configured to synthesize speech outputs for presentation to the worker. Speech synthesis component 524 may synthesize speech outputs based on text provided by the digital assistant. For example, the generated dialogue response may be in the form of a text string. Speech synthesis component 524 may convert the text string to an audible speech output, such as a set of utterances. Speech synthesis component 524 may use any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis component 524 may be configured to synthesize individual words based on phonemic strings corresponding to the words. For example, a phonemic string is associated with a word in the generated dialogue response. The phonemic string may be stored in metadata associated with the word. Speech synthesis component 524 may be configured to directly process the phonemic string in the metadata to synthesize the word in speech form.

In some examples, instead of (or in addition to) using speech synthesis component 524, speech synthesis is performed on a remote computing device separate from the computing device that includes safety assistant 500, and the synthesized speech is sent to the worker device for output to the worker. For example, this can occur in some implementations where outputs for a digital assistant are generated at a server system. And because server systems generally have more processing power or resources than a worker device, it is possible to obtain higher quality speech outputs than would be practical with client-side synthesis.

Additional details on digital assistants can be found in the U.S. Utility application Ser. No. 15/713,503, entitled “Offline Personal Assistant,” filed Sep. 22, 2017; U.S. Utility application Ser. No. 12/987,982, entitled “Intelligent Automated Assistant,” filed Jan. 10, 2011; and U.S. Utility application Ser. No. 13/251,088, entitled “Generating and Processing Task Items That Represent Tasks to Perform,” filed Sep. 30, 2011, the entire disclosures of which are incorporated herein by reference.

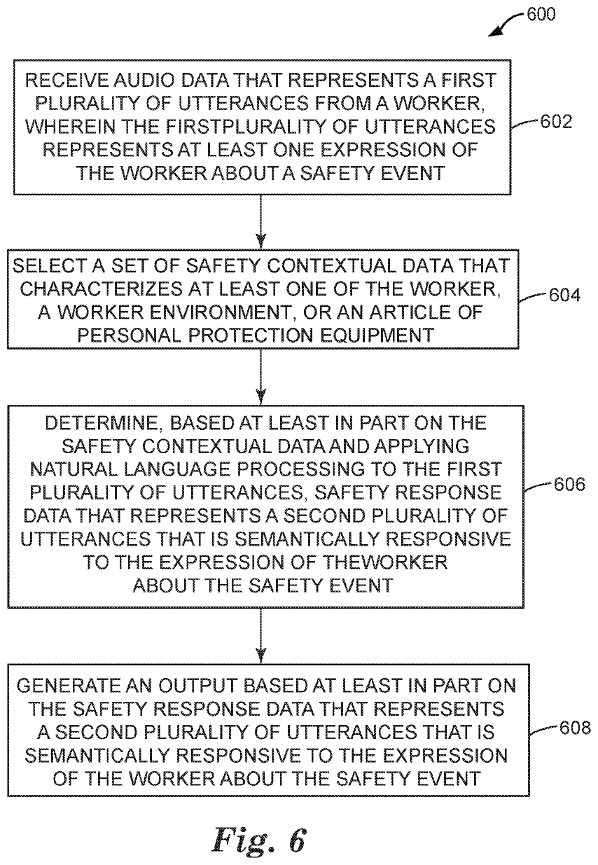

FIG. 6 is a flow diagram illustrating example operations 600 of a computing device, in accordance with one or more techniques of this disclosure. The techniques are described in terms of computing device 302 of FIG. 3. However, the techniques may be performed by other computing devices. In the example of FIG. 6, computing device 302 may receive audio data that represents a first plurality of utterances from a worker (602). The first plurality of utterances may represent at least one expression of the worker about a safety event. Computing device 302 may select a set of safety context data that characterizes at least one of the worker, a worker environment, or an article of personal protection equipment (604). Computing device 302 may determine, based at least in part on the safety context data and applying natural language processing to the first plurality of utterances, safety response data that represents a second plurality of utterances that is semantically responsive to the expression of the worker about the safety event (606). Computing device 302 may generate an output based at least in part on the safety response data that represents a second plurality of utterances that is semantically responsive to the expression of the worker about the safety event (608).

Although techniques of this disclosure have been described with computing device 302 providing a second set of utterances generated by the safety assistant, in other examples, the safety assistant may perform one or more operations without generating the second set of utterances. For example, a computing device may receive audio data that represents a set of utterances that represents at least one expression of the worker. The computing device may determine, based applying natural language processing to the set of utterances, safety response data. The computing device may perform at least one operation based at least in part on the safety response data. Accordingly, the computing device may perform any operations described in this disclosure or otherwise suitable in response to a set of utterances that represents at least one expression of the worker, such as but not limited to: configuring PPE, sending messages to other computing devices, or performing any other operations.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A computing device comprising:
one or more computer processors; and
a memory comprising instructions that, when executed by the one or more computer processors, cause the one or more computer processors to:
receive audio data that represents a first plurality of utterances from a worker, wherein the first plurality of utterances represents at least one expression of the worker about a safety event;
select a set of safety context data that characterizes a worker environment, one or more workers, or an article of personal protection equipment;
determine, based at least in part on the safety context data and applying natural language processing to the first plurality of utterances, safety response data that represents a second plurality of utterances that is semantically responsive to the expression of the worker about the safety event; and
generate an output based at least in part on the safety response data that represents a second plurality of utterances that is semantically responsive to the expression of the worker about the safety event.

2. The computing device of claim 1, wherein to determine safety response data that represents the second plurality of utterances that is semantically responsive to the expression of the worker about the safety event, the memory comprising instructions that, when executed, cause the one or more computer processors to:
determine a set of phonetic features that correspond to the first set of utterances that represents the at least one expression of the worker about the safety event;
determine, based at least in part on the phonetic features, a set of words included in a spoken language that represent the expression of the worker about the safety event;
determine, based at least in part on the safety context data and one or more semantic relationships between the set of words that represent the expression of the worker about the safety event, the safety response data that is semantically responsive to the expression of the worker about the safety event.

3. The computing device of claim 2, wherein the set of words is a first set of words, wherein to determine, based at least in part on the safety context data and the one or more semantic relationships between the set of words that represent the expression of the worker about the safety event, the safety response data, the memory comprising instructions that, when executed, cause the one or more computer processors to:
determine, based at least in part on the first set of words, at least one of an operation or a second set of words that correspond to the safety context data; and
determine the safety response data based at least in part on at least one of the operation or the second set of words that correspond to the safety context data.

4. The computing device of claim 3, wherein to determine the safety response data, the memory comprising instructions that, when executed, cause the one or more computer processors to:
determine a second set of phonetic features that correspond to the second set of words; and
encode, based at least in part on the second set of phonetic features, audio data in the safety response data that represents second plurality of utterances.

5. The computing device of claim 1, wherein the computing device is configured with personal protection equipment configured to be worn by the worker.

6. The computing device of claim 5, wherein the computing device is physically attached to the personal protection equipment configured to be worn by the worker.

7. The computing device of claim 1, wherein the at least one expression of the worker about the safety event comprises an inquiry whether one or more states of the personal protection equipment of the worker satisfy one or more pre-defined conditions for use by the worker, wherein to generate an output based at least in part on the safety response data, the memory comprises instructions that, when executed, cause the one or more computer processors to:
identify the personal protection equipment based at least in part on an association between the worker and the personal protection equipment;
determine, based at least in part on the safety context data, whether one or more states of the identified personal protection equipment of the worker satisfy the one or more pre-defined conditions; and
determine the safety response data based at least in part on whether the identified personal protection equipment of the worker satisfies the one or more pre-defined conditions.

8. The computing device of claim 7, wherein the safety event comprises the one or more states of the personal protection equipment of the worker not satisfying the one or more pre-defined conditions for use by the worker.

9. The computing device of claim 1, wherein the at least one expression of the worker about the safety event comprises an inquiry whether one or more states of a work environment of the worker satisfy one or more pre-defined conditions, wherein to generate an output based at least in part on the safety response data, the memory comprises instructions that, when executed, cause the one or more computer processors to:
identify the work environment based at least in part on an association between the worker and the work environment;
determine, based at least in part on the safety context data, whether one or more states of the work environment of the worker satisfy the one or more pre-defined conditions; and
determine the safety response data based at least in part on whether one or more states of the work environment of the worker satisfy the one or more pre-defined conditions.

10. The computing device of claim 9, wherein the safety event comprises the one or more states of the work environment not satisfying the one or more pre-defined conditions.

11. The computing device of claim 1, wherein the at least one expression of the worker about the safety event comprises an inquiry whether one or more states of the worker satisfy one or more pre-defined conditions, wherein to generate an output based at least in part on the safety response data, the memory comprises instructions that, when executed, cause the one or more computer processors to:
identify the worker;
determine, based at least in part on the safety context data, whether one or more states of the worker satisfy the one or more pre-defined conditions; and
determine the safety response data based at least in part on whether the one or more states of the worker satisfy the one or more pre-defined conditions.

12. The computing device of claim 11, wherein the safety event comprises the one or more states of the of the worker not satisfying the one or more pre-defined conditions.

13. The computing device of claim 1, wherein the set of safety context data comprises at least one of historical safety context data or in situ safety context data received from one or more sensors configured at one or more of the worker, a work environment of the worker, or personal protection equipment of the worker.

14. The computing device of claim 1, wherein to determine the safety response data that represents the second plurality of utterances the memory comprises instructions that, when executed, cause the one or more computer processors to:
determine a sentiment state of the at least one expression of the worker from natural language processing of the first plurality of utterances; and
determine, based at least in part on the sentiment state, the safety response data.

15. The computing device of claim 1, wherein safety context data that characterizes the one or more workers comprises at least one of worker identity, worker experience, worker training, worker location, worker physiological metric, or worker role.

16. The computing device of claim 1, wherein safety context data that characterizes the work environment comprises at least one of work environment identity, work environment location, work environment climate, work environment owner, work environment hazard, work environment type, or work environment condition.

17. The computing device of claim 1, wherein safety context data that characterizes the personal protection equipment comprises at least one of PPE type, PPE model, PPE issue date, PPE owner, or PPE use time.

18. The computing device of claim 1, wherein the output indicates one or more remedial actions that are semantically responsive to the expression of the worker about the safety event.

19. The computing device of claim 1, wherein the first plurality of utterances from the worker indicates a PPE fit test and the output is based at least in part on whether the PPE fit test, initiated in response to the first plurality of utterances, passed or failed.

20. The computing device of claim 1, wherein the first plurality of utterances from the worker correspond to at least two of a worker, work environment, or personal protection equipment, wherein to determine the safety response data, the memory comprises instructions that, when executed, cause the one or more computer processors to determine the safety response data based at least in part on the at least two of the worker, the work environment, or the personal protection equipment.

21-30. (canceled)
